(19) United States
(12) Patent Application Publication
(10) Pub. No.: US 2026/0117021 A1
(43) Pub. Date: Apr. 30, 2026

(54) POLYPROPIOLACTONES AND METHODS OF PREPARATION USING IONIC LIQUIDS

(71) Applicant: Novomer, Inc., Rochester, NY (US)

(72) Inventors: Christopher A. DeRosa, Rochester, NY (US); Catherine A. Falkner, Rochester, NY (US)

(21) Appl. No.: 19/149,893

(22) PCT Filed: Jan. 29, 2024
(86) PCT No.: PCT/US2024/013292

§ 371 Date: Jul. 22, 2025

Related U.S. Application Data
(60) Provisional application No. 63/442,951, filed on Feb. 2, 2023.

(51) Int. Cl. C08G 63/08; C08G 63/78; C08G 63/91; C08J 3/24

(52) U.S. Cl. CPC C08G 63/08; C08G 63/78; C08G 63/912; C08J 3/245; C08J 2367/04

(57) ABSTRACT

Disclosed are methods of efficiently making polypropiolactone and related copolymers from beta propiolactone utilizing carboxylate salts of an onium cation. In another aspect, the present invention provides polymerization systems comprising combinations of initiators and monomers that together enable the efficient production of polypropiolactone and related copolymers. Disclosed are novel polymer compositions having structures and/or compositional characteristics that differentiate them from previously produced polymers and polymer compositions.

### TECHNICAL FIELD

This disclosure relates to polymer systems comprising polypropiolactones having on one end of a portion of the chains a residue of a phosphate anion covalently bonded to the one end of the polymer chains and on the other end of a portion of the chains is one or more onium based cations. This disclosure also relates to polymerizable compositions and methods for preparation of such polymer systems utilizing ionic liquids containing phosphate cations.

### BACKGROUND

Polyester polymers have proven to be versatile materials with a wide range of uses. Polyesters based on petroleum-derived aromatic monomers are among the most widely utilized polymers, for example polyethylene terephthalate (PET) is produced on a massive scale for the production of water bottles, textiles and other consumer goods. Unfortunately, PET is not biodegradable and as such has become a major contributor to the growing problem of environmental contamination by residual post-consumer plastic wastes, including damage to marine ecosystems. In recent years there has been increasing interest in biodegradable polyesters, examples include polylactic acid (PLA) and poly-3-hydroxybutyrate (PHB). These polymers' high cost and properties have made it difficult to serve large volume applications to displace incumbent high-volume polymers. There remains a need for high performance biodegradable polyesters and for methods of making such polymers from flexible feedstock sources that allow manufacturers to balance the cost and sustainability profiles of their products.

While the polymerization of beta propiolactone (BPL) and related substituted beta lactones has been known for decades, it has not previously been possible to economically produce very high molecular weight polypropiolactones or related copolymers, nor has it been straightforward to control the compositional properties and secondary structures of such polymers to optimize them for a range of applications. The time for the preparation of polypropiolactones can be lengthy and there is a need for methods to prepare such polymers which requires less processing time.

What are needed are polymers prepared from beta-lactones having higher and controllable molecular weights. What are needed are polymers prepared from beta-lactones having controllable polydispersity's. What are needed are methods of preparing such polymers which allow the preparation of polymer systems with the desired molecular weights and polydispersity's. What are needed are methods for the preparation of polypropiolactones which require less time and provide for control of the molecular weights and polydispersity's of the formed polymers.

### SUMMARY

Disclosed are polymers comprising one or more polymer chains having units derived from ring opened beta-lactones and having on one end of a portion of the chains a residue of a phosphate anion covalently bonded to the one end of the polymer chains. The polymers may have a mixture of the residue of a carboxylate anion and a residue of a phosphate anions on one end of the polymer. The other end of a portion of the chains may one or more onium cations. The onium cations may contain one or more of nitrogen, phosphorus, sulfur, antimony or arsenic. The onium cations may contain one or more of nitrogen and phosphorus. The onium cations may comprise one or more quaternary nitrogen containing cations or quaternary phosphonium containing cations.

The onium cation may be one or more of quaternary nitrogen or quaternary phosphonium containing cations. The one or more quaternary nitrogen containing cations may be quaternary amines wherein two or more of the groups bonded to the nitrogen may form one or more aromatic or non-aromatic ring structures which may optionally contain one or more heteroatoms. The one or more quaternary nitrogen containing cations may comprise one or more ammonium, amidinium, and guanidinium cations or an onium cation based on a nitrogen-containing heterocycle. The one or more quaternary nitrogen containing cations may comprise one or more of an onium cation based on a nitrogen-containing heterocycle comprising optionally substituted pyridinium, imidazolium, pyrrolidinium, or piperidinium. The one or more quaternary nitrogen containing cations may comprise one or more optionally substituted imidazolium cations. The one or more quaternary nitrogen containing cations are one or more ammonium cations which correspond to the formula

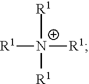

wherein R¹ is separately in each occurrence a group containing one or more carbon atoms wherein two or more of R¹ may form one or more aromatic or non-aromatic ring structures which may optionally contain one or more heteroatoms. The one or more quaternary nitrogen containing cations may be one or more guanidinium cations correspond to the formula:

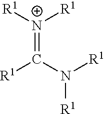

wherein R¹ is separately in each occurrence a caron containing group which may contain one or more heteroatoms. The one or more quaternary ammonium cations may be one or more tetraalkyl ammonium anions or an onium cation based on a nitrogen-containing heterocycle such as an optionally substituted pyridinium, imidazolium, pyrrolidinium, or piperidinium. The one or more quaternary ammonium cations may be one or more tetraalkyl ammonium anions or an onium cation based on a nitrogen-containing heterocycle such as an optionally substituted pyridinium, imidazolium, pyrrolidinium, or piperidinium. The one or more quaternary phosphonium cations may correspond to the formula:

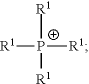

wherein R¹ is separately in each occurrence a carbon containing groups optionally containing one or more heteroatoms wherein two or more of R¹ may form one or more aromatic or non-aromatic ring structures which may optionally contain one or more heteroatoms. The one or more quaternary phosphonium cations may be tetraalkyl phosphonium cations.

Disclosed are polymers wherein the one or more polymer chains have the residue of an end capping agent or quenching agent on a portion of the ends of the chains. The end capping agents may comprise one or more electrophilic organic compounds. The end capping agent may be an organohalide, organosulfonate, a haloalkyl silane, an aniline derivative, a phosphate derivative, and an isophthalic acid derivative.

The polymer may contain a comonomer which polymerizes with ring opened beta-lactones. The comonomers may be one or more of caprolactones, lactides, epoxides, oxetanes, cyclic anhydrides, cyclic ethers, lactams, episulfides, aziridines, (meth)acrylates, valerolactones, butyrolactone, glycolides and substituted glycolides; and may be one or more epoxides.

Disclosed is a polymerizable composition comprising: a) one or more of beta-lactones; and b) one or more salts or zwitterions of one or more onium containing cations and one or more phosphate anions. The one or more salts of one or more one or onium containing cations and one or more phosphate anions may be based on any one or more of those cations and anions disclosed hereinbefore.

The one or more salts of one or more quaternary nitrogen containing cations or quaternary phosphonium cations and one or more phosphate anions may correspond to one of the formulas

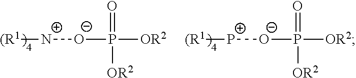

wherein R¹ is separately in each occurrence a carbon group containing optionally containing one or more heteroatoms wherein two or more of R¹ may form one or more aromatic or non-aromatic ring structures which may optionally contain one or more heteroatoms; and, wherein R² is separately in each occurrence a carbon group containing optionally containing one or more heteroatoms.

The one or more salts of one or more one or more quaternary nitrogen containing cations and one or more phosphate anions may correspond to the formula:

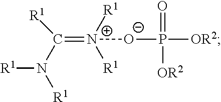

wherein R¹ and, R² is separately in each occurrence a hydrocarbyl group are previously defined.

The one or more salts of one or more one or more quaternary nitrogen containing cations and one or more phosphate anions may correspond to the formula:

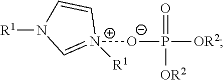

wherein R¹ and R² are previously defined.

The disclosed polymerizable composition may comprise one or more of chain transfer agents, chain extenders, quenching agents and end capping agents. The disclosed polymerizable compositions may exhibit a ratio of the one or more of beta-lactones to the one or more salts or zwitterions containing one or more onium cations and one or more phosphate anions of from about 10 to 1 to about 1,000,000 to 1. The end-capping or quenching agent may be present in an amount of less than 10 molar equivalents relative to the amount of the one or more salts or zwitterions one or more onium cations and one or more phosphate anions.

Disclosed are methods comprising contacting one or more of beta-lactones, and, optionally, comonomers, with one or more salts or zwitterions containing one or more onium cations and one or more phosphate anions under conditions to prepare one or more polymers comprising one or more polymer chains having ring opened beta-lactone units. The disclosed onium cations may be any of those disclosed herein. The disclosed one or more phosphate anions are any disclosed herein. The disclosed method may involve contacting the polymerizable compositions from about 30° C. to about 120° C. The polymerizable composition may be contacted at a pressure of from about 1 bar (0.1 MPa) to about 20 bar (2.0 MPa).

The one or more salts or zwitterions containing one or more onium cations and one or more phosphate anions may form ionic liquids which can blend well with liquid ingredients in the disclosed compositions and may perform as carriers for certain solid ingredients. Such ionic liquids provide advantages in utilization due to their liquid nature. Such compounds in the liquid form can perform their functions when added to the polymerizable compositions. Ingredients which are solid may have an induction period due to the need for them to dissolve into the reaction mixture before they are able to function. These ionic liquids do not require such induction period.

The use of compounds containing phosphorus-based anions can deliver higher molar masses in shorter amounts of time. These salts are obtained as low-melting point solids and can be utilized as liquid-like initiators for the slurry polymerization of beta-lactones. The polymers exhibit controllable molecular weights and controllable polydispersity. The methods disclosed provide means of controlling the molecular weights and polydispersity. The disclosed polymers may exhibit higher molecular weights than previous known for polymers comprising one or more polymer chains having ring opened betapropiolactone and/or substituted betapropiolactone units.

### BRIEF DESCRIPTION OF FIGURES

FIG. 1 illustrates the molar mass [Mn] dependence on monobasic ionic liquid equivalence versus beta-propiolactone ratio.

FIG. 2 illustrates the molar mass [Mₙ] dependence on tribasic ionic liquid equivalence versus beta-lactone ratio.

FIGS. 3a and 3b illustrate 1H NMR spectroscopy (500 MHz; CDCl₃) of P3HP prepared using octadecyl-trimethylammonium dimethyl phosphate.

FIG. 4 illustrates 1H NMR spectroscopy (500 MHz; CDCl₃) of P3HP prepared using tris(tetramethylammonium) phosphate.

FIG. 5 illustrates molar mass [g/mol] of P3HP using ODTMA DMP as a catalyst according to GPC and 1H NMR spectroscopy using end-group analysis.

FIG. 6 illustrates the temperature dependence on polymer molar mass [Mₙ] using ODTMA DMP as an additive [monomer to ionic liquid ratio=500:1,

FIG. 7 illustrates the comparison of beta-lactone conversion versus time with various polymerization additives.

### DETAILED DESCRIPTION

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

Polymers disclosed may comprise one or more crystalline polymorphs, and can exist in various crystalline forms. The term “beta-lactone” refers to a substituted or unsubstituted cyclic ester having a four-membered ring comprising an oxygen atom, a carbonyl group and two optionally substituted methylene groups. Unsubstituted beta lactone are referred to as propiolactone. Substituted beta lactones include monosubstituted, disubstituted, trisubstituted, and tetrasubstituted beta lactones. The beta lactones may comprise a single lactone moiety. The beta lactones may comprise two or more four-membered cyclic ester moieties. Substantially all means that 95 percent or greater of the referenced parameter or material is present, 98 percent or greater or 99 percent or greater, wherein the percent may be weight or mole percent based based on the context.

The term “epoxide”, as used herein, refers to a substituted or unsubstituted oxirane. Such substituted oxiranes include monosubstituted oxiranes, disubstituted oxiranes, trisubstituted oxiranes, and tetrasubstituted oxiranes. Such epoxides may be further optionally substituted as defined herein. The epoxides may comprise a single oxirane moiety. The epoxides comprise two or more oxirane moieties.

The term “polymer”, as used herein, refers to a molecule of high relative molecular mass, the structure of which comprises the multiple repetition of units derived, actually or conceptually, from molecules of low relative molecular mass. The polymer may be comprised of beta-lactone monomers (e.g., polypropiolactone) or derived therefrom. The polymers disclosed may be a copolymer, terpolymer, heteropolymer, block copolymer, or tapered heteropolymer incorporating two or more different monomers.

The terms “halo” and “halogen” as used herein refer to an atom selected from fluorine (fluoro, —F), chlorine (chloro, —Cl), bromine (bromo, —Br), and iodine (iodo, —I). Carbon containing group means a group with a carbon backbone, commonly referred to as hydrocarbyl groups and include the variations described in this paragraph. The term “aliphatic” or “aliphatic group”, as used herein, denotes a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic. Aliphatic groups may contain 1-40 carbon atoms, 1-20 carbon atoms, 2-20 carbon atoms, 1-12 carbon atoms, 1-8 carbon atoms, 1-6 carbon atoms, 1-5 carbon atoms, 1-4 carbon atoms, 1-3 carbon atoms, or 1 or 2 carbon atoms. Aliphatic groups include, but are not limited to, linear or branched, alkyl, alkenyl, and alkynyl groups, and hybrids thereof such as (cycloalkyl)alkyl, (cycloalkenyl)alkyl or (cycloalkyl)alkenyl.

The term “heteroaliphatic,” as used herein, refers to aliphatic groups wherein one or more carbon atoms are independently replaced by one or more atoms selected from the group consisting of oxygen, sulfur, nitrogen, or phosphorus. Heteroaliphatic groups may be substituted or unsubstituted, branched or unbranched, cyclic or acyclic, and include saturated, unsaturated, or partially unsaturated groups.

The term “unsaturated”, as used herein, means that a moiety has one or more double or triple bonds. The terms “cycloaliphatic”, “carbocycle”, or “carbocyclic”, used alone or as part of a larger moiety, refer to a saturated or partially unsaturated cyclic aliphatic monocyclic or polycyclic ring system, as described herein, having from 3 to 12 members, wherein the aliphatic ring system is optionally substituted as defined below and described herein. Cycloaliphatic groups include, without limitation, cyclopropyl, cyclobutyl, cyclopentyl, cyclopentenyl, cyclohexyl, cyclohexenyl, cycloheptyl, cycloheptenyl, cyclooctyl, cyclooctenyl, norbornyl, adamantyl, and cyclooctadienyl. A cycloaliphatic group may have 3-6 carbons. The terms “cycloaliphatic”, “carbocycle” or “carbocyclic” also include aliphatic rings that are fused to one or more aromatic or nonaromatic rings, such as decahydronaphthyl or tetrahydronaphthyl, where the radical or point of attachment is on the aliphatic ring. The term “alkenyl,” as used herein, denotes a monovalent group derived from a straight- or branched-chain aliphatic moiety having at least one carbon-carbon double bond by the removal of a single hydrogen atom. The term “alkynyl,” as used herein, refers to a monovalent group derived from a straight- or branched-chain aliphatic moiety having at least one carbon-carbon triple bond by the removal of a single hydrogen atom. The term “alkoxy”, as used herein refers to an alkyl group, as previously defined, attached to the parent molecule through an oxygen atom. Examples of alkoxy, include but are not limited to, methoxy, ethoxy, propoxy, isopropoxy, n-butoxy, tert-butoxy, neopentoxy, and n-hexoxy. The term “acyl”, as used herein, refers to a carbonyl-containing functionality, e.g., —C(═O) R′, wherein R′ is hydrogen or an optionally substituted aliphatic, heteroaliphatic, heterocyclic, aryl, heteroaryl group, or is a substituted (e.g., with hydrogen or aliphatic, heteroaliphatic, aryl, or heteroaryl moieties) oxygen or nitrogen containing functionality (e.g., forming a carboxylic acid, ester, or amide functionality). The term “acyloxy”, as used here, refers to an acyl group attached to the parent molecule through an oxygen atom. The term “aryl” used alone or as part of a larger moiety as in “aralkyl”, “aralkoxy”, or “aryloxyalkyl”, refers to monocyclic and polycyclic ring systems having a total of five to 20 ring members, wherein at least one ring in the system is aromatic and wherein each ring in the system contains three to twelve ring members. The term “aryl” may be used interchangeably with the term “aryl ring” wherein “aryl” refers to an aromatic ring system which includes, but is not limited to, phenyl, biphenyl, naphthyl, anthracyl and the like, which may bear one or more substituents. Also included within the scope of the term “aryl”, as it is used herein, is a group in which an aromatic ring is fused to one or more additional rings, such as benzofuranyl, indanyl, phthalimidyl, naphthimidyl, phenantriidinyl, or tetrahydronaphthyl, and the like, where the radical or point of attachment is on the aryl ring.

The terms “heteroaryl” and “heteroar-”, used alone or as part of a larger moiety, e.g., “heteroaralkyl”, or “heteroaralkoxy”, refer to groups having 5 to 14 ring atoms, preferably 5, 6, or 9 ring atoms; having 6, 10, or 14π electrons shared in a cyclic array; and having, in addition to carbon atoms, from one to five heteroatoms. The term “heteroaryl” may be used interchangeably with the terms “heteroaryl ring” and “heteroaryl group”, any of which terms include rings that are optionally substituted. The term “heteroatom” refers to nitrogen, oxygen, or sulfur, and includes any oxidized form of nitrogen or sulfur, and any quaternized form of a basic nitrogen. A heteroaryl group may be mono- or bicyclic. “Heteroaralkyl” refers to an alkyl group substituted by a heteroaryl, wherein the alkyl and heteroaryl portions independently are optionally substituted. The term “partially unsaturated” refers to a ring moiety that includes at least one double or triple bond.

As described herein, compounds disclosed may contain “optionally substituted” moieties. The term “substituted”, whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned are those that result in the formation of stable or chemically feasible compounds. The term “stable”, as used herein, refers to compounds that are not substantially altered when subjected to conditions to allow for their production, detection, and, in certain embodiments, their recovery, purification, and use for one or more of the purposes disclosed herein.

As used herein the term “alkoxylated” means that one or more functional groups on a molecule (usually the functional group is an alcohol, amine, or carboxylic acid, but is not strictly limited to these) has appended to it a hydroxy-terminated alkyl chain. Alkoxylated compounds may comprise a single alkyl group or they may be oligomeric moieties such as hydroxyl-terminated polyethers. Alkoxylated materials can be derived from the parent compounds by treatment of the functional groups with epoxides. Unless otherwise specified, “a,” “an,” “the,” and “at least one” are used interchangeably and mean one or more than one.

In certain structures disclosed parts of the structure are connected by a dotted line - - - - - - which indicates that the connected structures are ionically bonded together.

Disclosed are polymers comprising one or more polymer chains having units derived from ring opened beta-lactones and having on one end of a portion of the chains a residue of a phosphate anion covalently bonded to the one end of the polymer chains. The polymers may have a mixture of the residue of a carboxylate anion and a residue of a phosphate anion bonded to the one end of the polymer chains. The other end of a portion of the chains may one or more onium cations. Also disclosed are polymerizable compositions comprising a. one or more of beta-lactones; and b. one or more salts or zwitterions containing one or more onium cations and one or more phosphate anions. The polymerizable compositions may prepare the disclosed polymers. The polymerizable compositions may prepare any known polymer derived from one or more beta-lactones, and optionally comonomers, as disclosed herein. Also disclosed are methods contacting one or more beta-lactones substituted betapropiolactones and, optionally, comonomers with one or more salts or zwitterions containing one or more onium cations and one or more phosphate anions under conditions to prepare one or more polymers comprising one or more polymer chains having ring opened beta-lactones units. The disclosed onium cations may be any of those disclosed herein. The disclosed one or more phosphate anions may be any disclosed herein. The polymers prepared from the polymerizable compositions and disclosed method may exhibit controllable molecular weights and polydispersity. Such polymers can have higher molecular weights than have been previously prepared. Such polymers may exhibit lower polydispersity than previously prepared.

The polymers prepared comprise monomer units derived from ring opened beta-lactones. The polymers may also contain units derived from comonomers. The formed polymers may be terminated on one end of the polymer with one or more of a quenching agent, the residue of an onium group, or the like. In the polymer formulas described herein such terminating groups are represented by Z. The onium groups and chain terminators are described hereinafter.

The polymers may on one end of a portion of the chains contain a residue of a phosphate anion covalently bonded to the one end of the polymer chains. The polymers may have a mixture of the residue of a carboxylate anion and a residue of a phosphate anion bonded to the one end of the polymer chains. The other end of a portion of the chains may one or more onium cations. The monomer units derived from the ring opened beta-lactones may correspond to the formula:

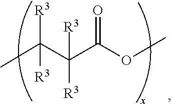

wherein R³ is independently in each occurrence hydrogen or a carbon containing group which may have one or more hydrogen or flourine atoms attached to the carbon atoms which a may optionally contain one or more heteroatoms and/or substituents; and, x is a real number of greater than 1. The variable x may be chosen such that the resulting polymer may have number average molecular weight of from about 500 to 2,000,000 g/mol. The variable x may be 3 to 50,000

The formed polymers may have on the other end of the polymer chains the residue of anionic initiator groups. Such residue may be based on any known initiator groups which may be separately added to the reaction mixture or generated in situ during the polymerization reaction.

The residue of the initiator may be one or more residues according to one of the formulas: D,

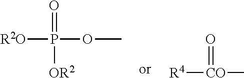

wherein D, R² and R⁴ are as defined herein.

The polymers prepared may correspond to the formula

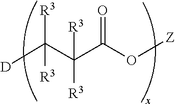

wherein D is the residue of one or more anionic initiators. The polymers prepared may have a portion of the polymer chains with a phosphate bonded to one end of the chain. Such polymers may correspond to one of the formulas:

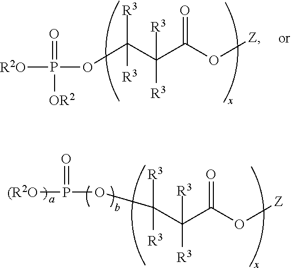

wherein R², R³, a, b, and x are as described herein; and,
Z is independently in each occurrence hydrogen, the residue of an onium cation, the residue of a quenching agent, and the like. A portion of the polymer chains may have a carboxylate group on the end of some of the chains. Such polymers may correspond to the formula:

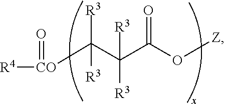

wherein R², R³, Z and x are as described herein; and,
R⁴ is independently in each occurrence a carbon containing group which may contain a heteroatom or be substituted with a functional group. The polymers prepared may contain polymers with different initiators on one end of the chain as described herein.

R¹ is separately in each occurrence a carbon containing group wherein two or more of R¹ may form one or more aromatic or non-aromatic ring structures which may optionally contain one or more heteroatoms. R¹ may be separately in each occurrence one of more alkyl groups, aryl groups, alkaryl groups, aralkyl groups which may contain heteroatoms or one or more unsaturated moieties, wherein two or more of R¹ may form a cycloalkyl group or cyclic ring comprising one or more aryl groups wherein such groups may contain heteroatoms and/or unsaturated groups. R¹ may be separately in each occurrence one of more C₁₋₂₀ alkyl groups, C₃₋₂₄ cycloalkyl groups, C₅₋₂₄ aryl groups, C₆₋₂₄ alkaryl groups, C₆₋₂₄ aralkyl groups which may contain heteroatoms or one or more unsaturated moieties. R¹ may be separately in each occurrence one of more C₁₋₁₂ alkyl groups, C₃₋₁₂ cycloalkyl groups, C₅₋₁₂ aryl groups, C₆₋₁₂ alkaryl groups, C₆₋₁₂ aralkyl groups which may contain heteroatoms or one or more unsaturated moieties. R¹ may be separately in each occurrence one or more C₁₋₁₂ alkyl groups which may contain heteroatoms or one or more unsaturated moieties. R¹ may be separately in each occurrence C₁₋₄ alkyl groups which may contain heteroatoms or one or more unsaturated moieties. R¹ may be separately in each occurrence may be one or more of methyl, ethyl, propyl or butyl groups.

R² is separately in each occurrence a carbon containing group which may contain heteroatoms or one or more unsaturated moieties. R² may be separately in each occurrence one of more alkyl groups, aryl groups, alkaryl groups, aralkyl groups which may contain heteroatoms or one or more unsaturated moieties, wherein two or more of R² may form a cycloalkyl group or cyclic ring comprising one or more aryl groups wherein such groups may contain heteroatoms and/or unsaturated groups. R² may be separately in each occurrence one of more C₁₋₂₀ alkyl groups, C₃₋₂₄ cycloalkyl groups, C₅₋₂₄ aryl groups, C₆₋₂₄ alkaryl groups, C₆₋₂₄ aralkyl groups which may contain heteroatoms or one or more unsaturated moieties. R¹ may be separately in each occurrence one of more C₁₋₁₂ alkyl groups, C₃₋₁₂ cycloalkyl groups, C₅₋₁₂ aryl groups, C₆₋₁₂ alkaryl groups, C₆₋₁₂ aralkyl groups which may contain heteroatoms or one or more unsaturated moieties. R² may be separately in each occurrence one or more C₁₋₁₂ alkyl groups which may contain heteroatoms or one or more unsaturated moieties. R² may be separately in each occurrence C₁₋₄ alkyl groups which may contain heteroatoms or one or more unsaturated moieties. R² may be separately in each occurrence may be one or more of methyl, ethyl, propyl or butyl groups.

One or more of R³ may be a carbon containing group which may have one or more hydrogen or fluorine atoms bonded to carbon atoms, the carbon containing groups may contain one or more of unsaturated groups, electrophilic groups, nucleophilic groups, anionic groups, cationic groups, zwitterion containing groups, hydrophobic groups, hydrophilic groups, halogen atoms, natural minerals, synthetic minerals, carbon-based particles, an ultraviolet active group, a polymer having surfactant properties, and polymerization initiators or reactive heterocyclic rings. The functional groups may be linked to the ring by a linking group (M) which functions to link the functional portion of the groups to the cyclic ring. Exemplary linking groups may be carbon containing groups, ethers, thioethers, polyethers (such as polyalkene ether). One or more of R³ may be a halogen substituted alkyl group, a sulfonic acid substituted alkyloxy group; an alkyl sulfonate alkyloxy group; alkyl ether substituted alkyl group; a polyalkylene oxide substituted alkyl group, an alkyl ester substituted alkyl group; an alkenyloxy substituted alkyl group; an aryl ester substituted alkyl group; an alkenyl group; a cyano-substituted alkyl group; an alkenyl ester substituted alkyl group; a cycloalkyl substituted alkyl group; an aryl group; a heteroatom containing cycloalkenyl, alkyl ether substituted alkyl group; a hydroxyl substituted alkyl group, a cycloaliphatic substituted alkenyl group; an aryl substituted alkyl group; a haloaryl substituted alkyl group; an aryloxy substituted alkyl group; an alkyl ether substituted alkaryl group; a hetero atom containing cycloaliphatic group substituted alkyl group; a hetero atom containing aryl substituted alkyl group, an alkyl amide substituted alkyl group, an alkenyl substituted cycloaliphatic group; two R³s may form a cyclic ring, which may optionally contain one or more unsaturated groups; an alkyl group substituted with a beta propiolactone group which may optionally be contain one or more ether groups and/or one or more hydroxyl groups; a glycidyl ether group, or a benzocyclobutenyl substituted alkyl group, optionally substituted with one or more ether groups. Beta propiolactone corresponds to the formula wherein all of the R³s are hydrogen. The R³s on one carbon atom may both be H while one or both R³s on the other carbon atom may be an optionally substituted C₁₋₄₀ aliphatic, optionally substituted C₁₋₂₀ heteroaliphatic, optionally substituted aryl or both R³ groups may be optionally taken together to form an optionally substituted ring optionally containing one or more heteroatoms. One or two of the R³s on different carbon atoms may be alkyl and the others may be hydrogen. The alkyl groups may be C₁₋₂₀ alkyl groups, C₁₋₁₂ alkyl groups, C₁₋₈ alkyl groups, C₁₋₄ alkyl groups, wherein the alkyl groups may contain unsaturation, heteroatoms or heteroatom containing functional groups. One or two of the R³s on different carbon atoms may be methyl or ethyl and the others may be hydrogen. Two R³s on the same carbon atom may be methyl while the other R³s are hydrogen.

R⁴ is independently in each occurrence a carbon containing group which may contain a heteroatom or be substituted with a functional group. R⁴ may be separately in each occurrence one of more alkyl groups, aryl groups, alkaryl groups, aralkyl groups which may contain heteroatoms or one or more unsaturated moieties, wherein two or more of R⁴ may form a cycloalkyl group or cyclic ring comprising one or more aryl groups wherein such groups may contain heteroatoms and/or unsaturated groups. R⁴ may be separately in each occurrence one of more C₁₋₂₀ alkyl groups, which may contain heteroatoms or one or more unsaturated moieties. R⁴ may be separately in each occurrence one of more C₁₋₁₂ alkyl groups, which may contain heteroatoms or one or more unsaturated moieties. R⁴ may be separately in each occurrence one or more C₁₋₁₂ alkyl groups which may contain heteroatoms or one or more unsaturated moieties. R⁴ may be separately in each occurrence C₁₋₄ alkyl groups which may contain heteroatoms or one or more unsaturated moieties. R⁴ may be separately in each occurrence may be one or more of methyl, ethyl, propyl or butyl groups. R⁴ may form an acrylate group with the carbonyl oxy moiety to which it is bonded.

The polymer composition formed may have a low polydispersity, for instance a polydispersity index (PDI) of 3.5 or less, 3.0 or less, 2.5 or less, 2.2 or less, 2.0 or less, 1.8 or less, 1.7 or less, 1.6 or less, 1.5 or less, 1.4 or less, 1.3 or less, 1.2 or less, 1.1 or less, 1.05 or less. The polymer composition formed may have a PDI of 1.05 or greater, 1.1 or greater, 1.2 or greater, 1.5 or greater or 2.0 or greater. The PDI values recited are measured by GPC (gel permeation chromatography) and calculated using standard software packages. Polydispersity is calculated from Mn (number average molecular weight) and Mw (weight average molecular weight) using the formula Mw/Mn. The PDI values may be calculated without inclusion of GPC peaks arising from oligomers having Mn below about 5,000 g/mol, less than about 4,500, less than about 4,000, less than about 3,500, less than about 3,000, less than about 2,500, less than about 2,000, less than about 1,500, or less than about 1,000 g/mol.

The polymers prepared may have number average molecular weights of greater than about 500 g/mol, 1,000 g/mol, 5,000 g/mol, 10,000 g/mol, 17,000 g/mol, 20,000 g/mol, 25,000 g/mol, 50,000 g/mol, 100,000 g/mol, 200,000 g/mol, 300,000 g/mol or 500,000 g/mol as measured as disclosed herein. The polymers prepared may have number average molecular weights 2,000,000 g/mol or less or 1,000,000 g/mol or less. The polymers prepared may have weight average molecular weights of greater than about 500 g/mol, 1,000 g/mol, 5,000 g/mol, 10,000 g/mol, 17,000 g/mol, 20,000 g/mol, 25,000 g/mol, 50,000 g/mol, 100,000 g/mol, 200,000 g/mol, 300,000 g/mol, 500,000 g/mol, 600,000 g/mol or 700,000 g/mol as measured as disclosed herein. The polymers prepared may have number average molecular weights of 2,000,000 g/mol or less or 1,000,000 g/mol or less. Molecular weights are measured by GPC (gel permeation chromatography) and calculated using standard software packages using THE as the solvent and referenced to monodisperse polymethyl methacrylate standards.

Disclosed are polymers containing the residue of beta-lactones. Functional groups on the beta-lactones may provide functionality to polymers and copolymers prepared from the beta-lactones. The functional groups may function as polymerization initiators, improve adhesion of the polymers to certain substrates or polymer systems, improve the hydrophobic or hydrophilic properties, improve the hardness or scratch resistance, polymerization catalysts, and the like. Polymers and copolymers of beta-lactones may function as intermediate layers in multilayer films, including such films having layers of different polymers. The polymers and copolymers of beta-lactones decompose under certain circumstances and allow the other layers to be easily separated for reuse on recycling. Polymers and copolymers of beta-lactones may function as intermediate layer between coatings of other polymers and a substrate. The polymers and copolymers of beta-lactones decompose under certain circumstances and allow the substrate to be easily separated from the other coating layers for reuse on recycling. The polymers and copolymers of beta-lactones can be used as the outside film layer or coating layer that can be decomposed or such outside layer can be functionalized to provide a desired set of properties to the structure.

The polymerizable composition may comprise a. one or more beta-lactones; and b. one or more salts or zwitterions containing one or more onium cations and one or more phosphate anions.

The beta-lactones which may be in the polymerizable compositions and used to prepare the polymers may be any betalactones which polymerize under the conditions defined in this application. The beta-lactones may correspond to the general formula:

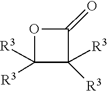

wherein R³ is as previously described.

Disclosed are homopolymers prepared from the beta-lactones described. Disclosed are copolymers of more than one beta-lactones. Disclosed are compositions comprising a copolymer of one or more beta-lactones disclosed with one or more monomers reactive with the one or more beta-lactones. Disclosed are compositions comprising a copolymer of one or more of the beta-lactones disclosed with one or more monomers reactive with the one or more beta-lactones. Such copolymers may include a plurality of one or more diols, difunctional poly alkyleneoxides, amine terminated polyalkylene oxides, one or more difunctional polyesters, lactams, lactides, cyclic lactones, cyclic anhydrides, cyclic ethers epoxides, episulfides, aziridines, (meth)acrylates, valerolactones, butyrolactone, glycolides, substituted glycolides or polyethers. Such comonomers may be one or more of epoxides, oxiranes, lactams, and lactides. The comonomer may be one or more cyclic anhydrides including succinic anhydride, methyl succinic anhydride, methyl diglycolic anhydride, methyl glutaric anhydride, maleic anhydride, phthalic anhydride, citraconic anhydride, trans-1,2-cyclohexanedicarboxylic anhydride. These copolymers may contain units derived from beta propiolactones. The copolymers disclosed may be block copolymers, random copolymers or one or more chains may be grafted to the polymer backbone.

The one or more beta-lactones may be:

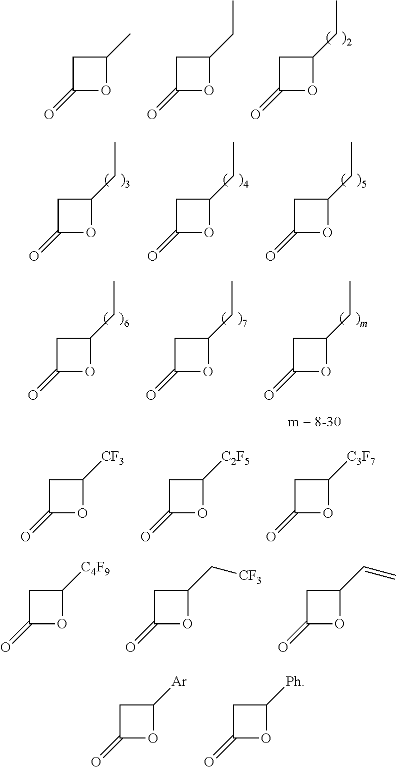

The one or more beta-lactones may be:

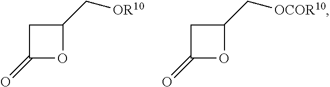

where R¹⁰ may be the same as R³. The one or more betalactones may be

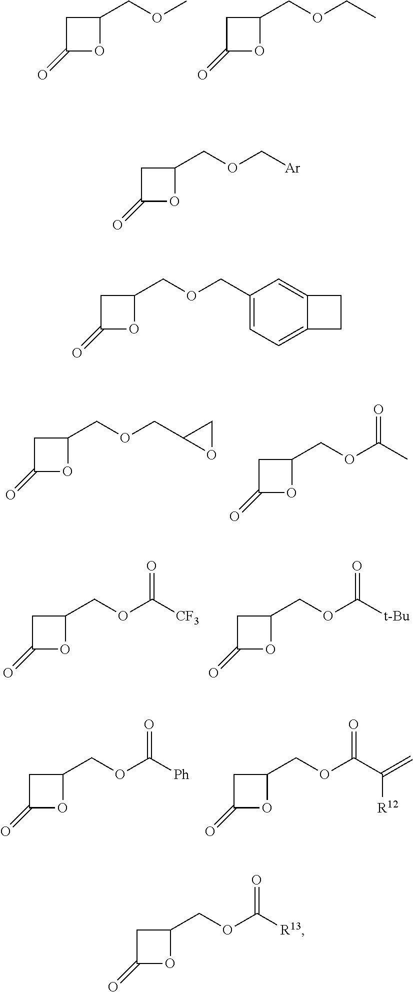

where Ar is any optionally substituted aryl group, R¹² is selected from the group consisting of: —H, optionally substituted C₁₋₂₀ aliphatic, optionally substituted C₁₋₂₀ heteroaliphatic, and optionally substituted aryl, and R¹³ is a fully or partially unsaturated C₂₋₂₀ straight chain aliphatic group. The polymers may be prepared from a mixture of betapropiolactone and pivalolactone:

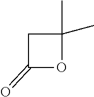

The one or more betalactones may be:

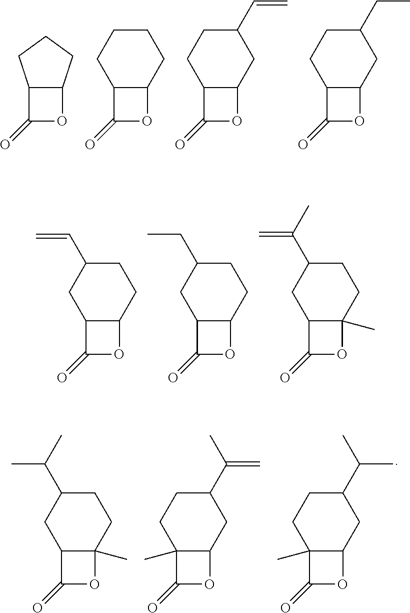

The polymers may be prepared from a beta propiolactone and a beta lactone of one of the formulas:

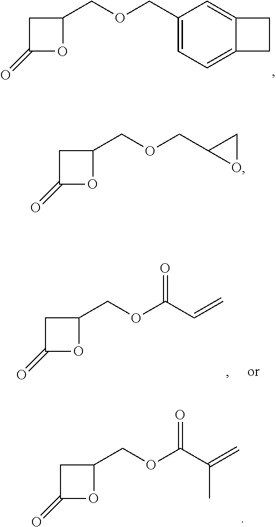 [SMILES: O=C1CC(COCc2ccc3c(c2)CC3)O1 ; O=C1CC(COCC2CO2)O1 ; C=CC(=O)OCC1CC(=O)O1 ; C=C(C)C(=O)OCC1CC(=O)O1]

The polymers may be prepared from a mixture of beta-lactones and wherein the beta-lactone is provided as a mixture of regioisomers. Any of the beta lactone comonomers described above may be provided in combination with their regioisomer(s). Where a beta-lactone comonomer is provided as a regioisomeric mixture, the regioisomer with the largest substituent on the carbon adjacent to the ring oxygen atom is present in molar excess relative to the other regioisomer. The major regioisomer is present in a ratio of 2:1 or greater relative to the minor regioisomer, at least 3:1, at least 5:1, at least 10:1, at least 20:1, at least 30:1, at least 40:1, at least 50:1, or at least 100:1 relative to the minor regioisomer.

The polymers may be prepared from a mixture of beta-lactones and one or more cyclic ethers including tetrahydrofuran, substituted tetrahydrofurans and epoxides. The epoxide may be a substituted epoxide. The epoxide may be one or more of ethylene oxide, propylene oxide, butylene oxide, 4-vinylcyclohexene oxide, 4-ethylcyclohexene oxide, limonene oxide, a glycidol ether, glycidol ester or cyclohexene oxide. The epoxides may correspond to the formula:

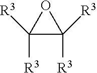

where R³ is as defined herein. The one or more substituted epoxides may correspond to the formula:

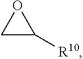

where R¹⁰ is as defined above. The one or more substituted epoxides may be:

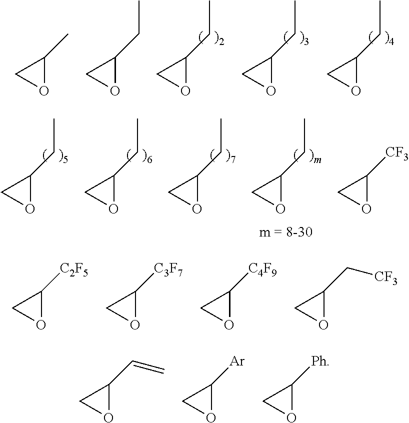

The one or more substituted epoxides may correspond to one of the formulas:

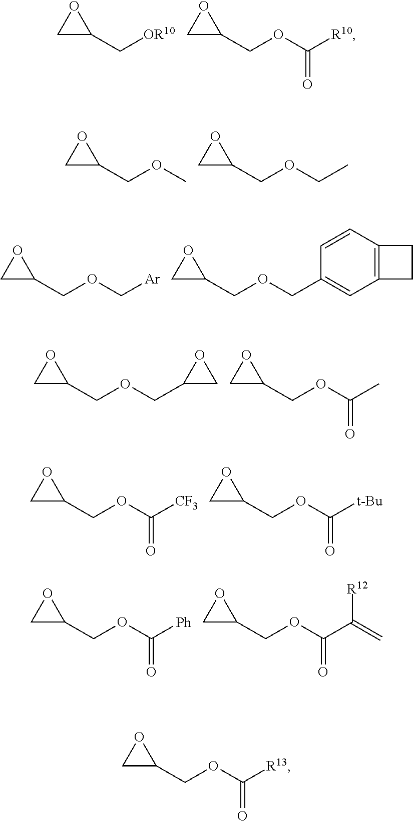

where each of Ar, R¹⁰, R¹², and R¹³ is as defined above. The one or more substituted epoxides may correspond to one of the formulas:

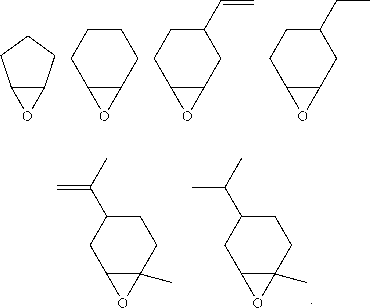

Disclosed are methods of polymerizing beta propiolactone (BPL) and/or substituted beta propiolactone optionally in combination with one or more additional co-monomers (collectively monomers), using an initiator as described herein. The initiator may, or may not be, covalently attached in the final polymer product.

The polymerizable composition comprises one or more salts or zwitterions containing one or more onium cations and one or more phosphate anions. The phosphate anions may initiate polymerization of the one or more beta-lactones and comonomers polymerizable therewith. The presence of the one or more salts or zwitterions containing one or more one or more onium cations and one or more phosphate anions may facilitate the formation in-situ of carboxylate anions which may initiate polymerization of such monomers. The presence of the one or more salts or zwitterions containing one or more one or more onium cations and one or more phosphate anions may result in the preparation of polymers wherein both of phosphate anions and carboxylate anions initiate polymer chains. The one or more salts or zwitterions of one or more onium cations and one or more phosphate anions may function to catalyze or accelerate the polymerization of the monomers.

The onium cations may be derived from any onium compound which enhances the formation of polymers as disclosed herein. The onium cations may comprise one or more of nitrogen, phosphorus, sulfur, antimony or arsenic. The onium cations may comprise one or more of nitrogen, phosphorus or sulfur. The onium cations may comprise one or more of nitrogen or phosphorus. The onium cations may comprise one or more quaternary nitrogen containing cations or quaternary phosphonium containing cations. The onium cations may comprise one or more quaternary nitrogen containing cations or quaternary phosphonium containing cations. The one or more quaternary nitrogen containing cations or quaternary phosphonium cations may comprise one or more tetraalkyl ammonium anions or tetraalkyl phosphonium anions.

The one or more quaternary nitrogen containing cations may contain four carbon containing groups bonded to the amine nitrogens wherein two or more of the carbon groups may form one or more aromatic or non-aromatic ring structures which may optionally contain one or more heteroatoms. The one or more quaternary nitrogen containing cations may comprise one or more nitrogen-containing heterocycles. The one or more nitrogen-containing heterocycles may comprise optionally substituted pyridinium, imidazolium, pyrrolidinium, or piperidinium moieties. The one or more quaternary nitrogen containing cations may comprise one or more optionally substituted imidazolium. The one or more quaternary nitrogen containing cations may comprise one or more ammonium, amidinium, and guanidinium cations. The one or more quaternary ammonium cations may correspond to the formula

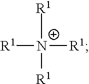

wherein R¹ is as defined herein. The one or more guanidinium cations may correspond to the formula:

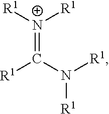

wherein R¹ is as defined herein.

The one or more quaternary ammonium cations may be one or more tetraalkyl ammonium anions or an onium cation based on a nitrogen-containing heterocycle such as an optionally substituted pyridinium, imidazolium, pyrrolidinium, or piperidinium. The one or more quaternary ammonium cations may be one or more tetraalkyl ammonium or N-alkyl substituted imidazolium cations. The one or more tetraalkyl ammonium cations may contain one or more of methyl, ethyl, propyl or butyl groups. The butyl groups may be n-butyl or tert-butyl. The one or more tetraalkyl ammonium cations may be tetra methyl ammonium, tetra ethyl ammonium or tetra tert-butyl ammonium

The one or more quaternary phosphonium cations may be one or more phosphonium cations containing four carbon containing groups. The one or more quaternary phosphonium cations may be one or more tetra alkyl phosphonium cations. The one or more quaternary phosphonium cations may correspond to the formula:

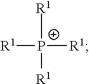

wherein R¹ is as defined herein.

The phosphate anion may be any phosphate anion which allows the one or more salts or zwitterions of one or more onium cations and one or more phosphate anions to perform the functions as disclosed herein. The phosphate anion may have from one to three onium cations bonded to oxygen groups. The phosphate anion may have from zero to two optionally substituted carbon containing groups bonded to oxygens. The phosphate anion may correspond to the formula;

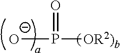

wherein R² is as defined herein, a is an integer of from 1 to 3 and b is an integer of from 0 to 2. Variable a may be 1, 2 or 3. Variable b may be 0, 1 or 2. The sum of a and b is 3. The anion may be a mixture of compounds wherein a and b are different in individual anions in the mixture. The phosphate anion may correspond to the formula;

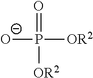

wherein R² is as defined herein.

The one or more salts of one or more onium cations and one or more phosphate anions may be any such salts that provide the properties as disclosed herein. Such salts are formed from the phosphate anions and onium cations disclosed herein and the various anions and cations described herein. The one or more salts of one or more onium cations and one or more phosphate anions may correspond to the formula

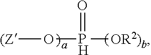

wherein R² is separately in each occurrence an optionally substituted hydrocarbyl group; Z′ is separately in each occurrence an onium cation as described herein including the variations described herein; a is separately in each occurrence 1, 2 or 3; and b is separately in each occurrence 0, 1 or 2; wherein the sum of a and b is 3.

The one or more salts of one or more quaternary nitrogen containing cations or quaternary phosphonium cations and one or more phosphate anions corresponds to one of the formulas:

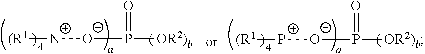

wherein R¹, R², a and b are as defined herein. The one or more salts of one or more quaternary nitrogen containing cations or quaternary phosphonium cations and one or more phosphate anions may correspond to one of the formulas:

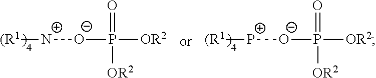

wherein R¹ and R² are as defined herein. The one or more salts of one or more quaternary nitrogen containing cations and one or more phosphate anions may correspond to the formula:

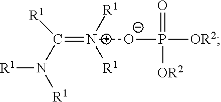

wherein R¹ and R² are as defined herein. The one or more salts of one or more one or more quaternary nitrogen containing cations and one or more phosphate anions may corresponds to the formula:

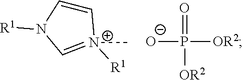

wherein R¹ and R² are as defined herein.

The polymerizable composition may comprise one or more zwitterions containing one or more onium cations, one or more phosphate anions and an optionally substituted carbon group between the anion and the cation with a bond to the anion and cation. The one or more zwitterions may be any of the defined zwitterions that provide the properties as disclosed herein. Such zwitterions are formed from the phosphate anions and onium cations disclosed herein and the various anions and cations described herein. The one or more zwitterions containing one or more onium cations, one or more phosphate anions and an optionally substituted hydrocarbylene moiety between the anions and the cations may correspond to the formula

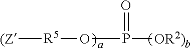

wherein R², R⁵, Z′, a and b are as defined herein. The zwitterions may correspond to one of the formulas:

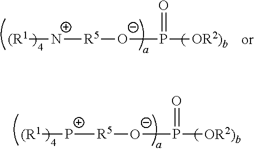

wherein R¹, R², R⁵, a and b are as defined herein. The one or more zwitterions of one or more quaternary nitrogen containing cations or quaternary phosphonium cations and one or more phosphate anions may correspond to one of the formulas:

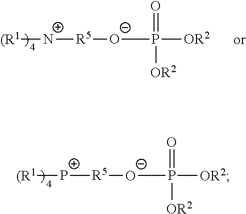

wherein R¹, R² and R⁵ are as defined herein. The one or more zwitterions containing one or more one or more quaternary nitrogen containing cations and one or more phosphate anions may correspond to the formula:

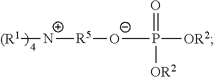

wherein R¹, R² and R⁵ are as defined herein. The one or more zwitterions of one or more quaternary nitrogen containing cations and one or more phosphate anions correspond to the formula:

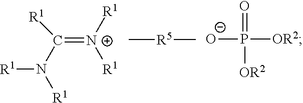

wherein R¹, R² and R⁵ are as defined herein. The one or more zwitterions of one or more one or more quaternary nitrogen containing cations and one or more phosphate anions may correspond to the formula:

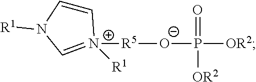

wherein R¹, R² and R⁵ are as defined herein. R⁵ is separately in each occurrence a carbon containing moiety which may be optionally substituted. R⁵ may be separately in each occurrence one of more alkylene groups, arylene groups, alkarylene groups, aralkylene groups which may contain heteroatoms or one or more unsaturated moieties, wherein two or more of R⁵ may form a cycloalkylene group or cyclic ring comprising one or more arylene groups wherein such groups may contain heteroatoms and/or unsaturated groups. R⁵ may be separately in each occurrence one of more C₁₋₂₀ alkylene groups, C₃₋₂₄ cycloalkylene groups, C₅₋₂₄ arylene groups, C₆₋₂₄ alkarylene groups, C₆₋₂₄ aralkylene groups which may contain heteroatoms or one or more unsaturated moieties. R⁵ may be separately in each occurrence one of more C₁₋₁₂ alkylene groups, C₃₋₁₂ cycloalkylene groups, C₅₋₁₂ arylene groups, C₆₋₁₂ alkarylene groups, C₆₋₁₂ aralkyl groups which may contain heteroatoms or one or more unsaturated moieties. R⁵ may be separately in each occurrence one or more C₁₋₁₂ alkyl groups which may contain heteroatoms or one or more unsaturated moieties. R⁵ may be separately in each occurrence C₁₋₄ alkylene groups which may contain heteroatoms or one or more unsaturated moieties. R¹ may be separately in each occurrence may be one or more of methylene, ethylene, propylene or butylene groups.

The polymerizable composition may contain one or more of end capping agents, quenching agents, chain extenders or branching agents. The quenching agent may be any compound which terminates the active end of the polymer during polymerization to stop the continued growth of the polymers. The quenching agent may be one or more of mineral acids, organic acids, and acidic resins or solids. The quenching agent may be HCl, H²SO₄, RSO₃H, HBr, H³PO₄, an acidic resin, or an acidic inorganic solid. The quenching agent may be a sulfonic acid derivative, boric acid or a boric acid derivative, phosphoric acid or a phosphoric acid derivative. The quenching agent may be a sulfonic acid. The sulfonic acid may be one or more of p-toluene sulfonic acid (also known as pTSA or tosylic acid), methane sulfonic acid, ethane sulfonic acid, 1-propane sulfonic acid, trifluoromethyl sulfonic acid, 4-nitrophenyl sulfonic acid, sulfoacetic acid, cumenesulphonic acid, xylene sulfonic acid, 3-amino-1-propanesulfonic acid, 2-sulfanyl ethanesulfonic acid, 3-hydroxy-1-propanesulfonic acid, benzenesulfonic acid, 4-hydroxybenzene sulfonic acid, cyclohexane sulfonic acid, 4-ethylbenzenesulfonic acid, 2,5-dimethylbenzene sulfonic acid, 4-methylmetanilic acid, 1-Naphthalenesulfonic acid or perfluorooctane sulfonic acid. The quenching agent may be methane sulfonic acid, p-toluene sulfonic acid or sulfamic acid. Acids used as quenching agents may act by protonating the active chain end(s) of the polymer (e.g. to form an —OH or CO2H group) with the anion of the acid acting as a counterion to the polymer bound cation from the initiator.

The quenching agent may be a phosphoric acid derivative having at least one acidic hydrogen atom. The phosphoric acid derivative may be one or more of phosphoric acid, pyrophosphoric acid, triphosphoric acid, an alkyl or aryl derivative of phosphoric acid, an alkyl or aryl derivative of pyrophosphoric acid, or an alkyl derivative or aryl of triphosphoric acid. The quenching agent may be a boron containing compound. The quenching agent may be fluoroboric acid. The quenching agent may be an acid associated with a solid support. The solid supported acid may comprise an inorganic solid selected from silica, alumina, zirconia, titania, zeolites, metal oxides, and clays. The quenched composition may form a polymer composite with the inorganic solid quench agent. The method may comprise adding a polymer supported acid as a quenching agent. The polymeric support may comprise a polymer derived from at least one of styrene, chloromethylated styrene and divinylbenzene monomers. The polymeric solid support may be one or more of polystyrenes, polysulfones, nylons, poly(chloromethylstyrene); polyolefins, polyacrylic acid, polymethylmethacrylate and cross-linked ethoxylate acrylate resins. Where the quenching agent comprises a solid, the method may comprise flowing a reaction stream comprising the unquenched polymer through a fixed bed of solid quench agent.

The end capping agents may comprise electrophilic organic compounds. The end capping agents may comprise one or more of an organohalide, organosulfonate, a haloalkyl silane, an aniline derivative, a phosphate derivative, a boric derivative, as disclosed herein, and an isophthalic acid derivative. The electrophilic organic compounds cap the growing chain ends and release an anion that satisfies the charge of the covalently bound cationic group. A compound R—X′ can react with an anionic chain end (e.g. to form an —OR or CO2R group) while the liberated anion X′-acts a counterion to the polymer bound cation. The end capping agent may comprise an alkyl halide, such as an aliphatic chloride, bromide, or iodide. The endcapping agent may comprise a compound of formula Rₙ—Xₕ, where Rₙ is an optionally substituted C₁₋₄₀ aliphatic group and Xₕ is selected from Cl, Br, or I. The end capping agent may comprise Rₚ—CH₂—Xₕ, where Rₚ is —H or an optionally substituted radical selected from the group consisting of aliphatic, aryl, heterocyclic, and heteroaryl. The end capping agent may be one or more of methyl bromide, methyl iodide, allyl chloride, allyl bromide, benzyl chloride, and benzyl bromide. The end capping agent may comprise an organosulfonate. The organosulfonate may correspond to the formula RₙOSO₂R_{q}, where Rₙ is as defined above and R_{q} is —H or an optionally substituted radical selected from the group consisting of aliphatic, aryl, heterocyclic, and heteroaryl. The quenching agent may comprise methyl triflate. The end capping agent may comprise of an organosulfate. The organosulfate may correspond to the formula RₙOSO₂ORₙ, where Rn is as defined above. The quenching agent may comprise a dialkyl sulfate, such as dimethyl sulfate or diethyl sulfate.

The end capping agent may be a silane which may comprises a compound that contains a silyl or siloxy group. The end capping agent may be a thermally stable aniline derivatives, which may include azoles such as those selected from the group consisting of benzothiazole, benzoxazole, benzimidazole, 2-aminothiophenol, o-phenylenediamine, and 2-aminophenol. Exemplary end-capping agents may further include phosphates such trimethylphosphate and triphenylphosphate. Exemplary end-capping agents may even further include other additives and stabilizers such as isophthalic acid.

The polymerizable composition may contain a chain extender or a branching agent The chain extender or branching agent may be added as a quenching agent. Analogs of the end capping agents described above having two or more suitable reactive functional groups in a single molecule may be utilized as quenching agents, they may act as chain extenders or branching agents respectively. Quenching with a difunctional chain extender result in reaction with the carboxylate ends of two separate polymer chains leading to the formation of a dimeric chain extended product. It will be appreciated that difunctional analogs of any of the quench agents described above can be utilized to similar effect. If a tri-functional or higher-functional end-capping agent is utilized, a branched, star or comb polymer composition may be obtained. Where the method comprises of a continuous process utilizing a plug-flow reactor, a quenching agent may be added at a particular point along the length of the reactor.

The formed polymer is prepared from a ratio of monomers to the initiators, such as phosphate and or carboxylate anions wherein a molar ratio of monomers to initiator is selected so as to prepare a polymer of the desired molecular weight, for example the mole ratio may be 10:1 or greater, 100:1 or greater, 1,000:1, or greater, 2,000:1 or greater, 3,000:1 or greater, 4,000:1 or greater, 5,000:1 or greater, 7,500:1 or greater, 10,000:1 or greater, 15,000:1 or greater. 20,000:1 or greater, 30,000:1 or greater, 40,000:1 or greater, 50,000:1 or greater, 75,000:1 or greater, or 100,000:1 or greater. The initiator is contacted with the monomers for sufficient time to prepare polymers of the desired molecular weight. The method may comprise the step of allowing the initiator to contact the monomers until a polymer composition having a number average molecular weight Mn as described herein is formed. Mn of the polymer composition refers to that measured by gel permeation chromatography (GPC) using THE as the solvent and referenced to monodisperse polymethyl methacrylate standards.

The method includes allowing the initiator to contact the monomers for a prescribed interval of time. The method may include the step of monitoring the progress of the polymerization reaction (for example by analyzing aliquots from the reaction mixture by a suitable technique such as GPC, or by utilizing in situ monitoring techniques). The method may include the step of monitoring the increase in the molecular weight of the polymer and/or monitoring a decrease in monomer concentration. The method may include stopping the reaction when the molecular weight of the polymer composition (or a proxy for molecular weight such as reaction viscosity) reaches a desired value or exceeds a predetermined threshold. The method may include the step of monitoring the depletion of monomers until their concentration reaches a desired concentration or falls below a predetermined threshold. The method may include the step of stopping the reaction when the concentration of monomers reaches a desired concentration or falls below a predetermined threshold.

The monomers may be contacted with the initiator in a solvent. The solvent may comprise polar non-protic solvent, such as amides, nitriles, and sulfoxides, protic liquids such as water or alcohols, an ether, ester, ketone or an aliphatic or aromatic hydrocarbon, halogenated hydrocarbon, or a fluorinated hydrocarbon. The solvent may comprise a C₄₋₁₂ aliphatic hydrocarbon, an ether or a chlorinated hydrocarbon. The solvent may comprise an ether petroleum ether, isobutane, pentanes, hexanes, or heptanes, or higher aliphatic hydrocarbons. The solvent may comprise isobutane or hexane. The solvent may be substantially anhydrous. The solvent may comprise an ether selected from tetrahydrofuran, 1,4 dioxane, 1,3-dioxane, dimethoxyethane, diglyme, triglyme, tetraglyme, 1,3 dioxolane, t-butylmethyl ether, and diethyl ether. The solvent may comprise tetrahydrofuran which may be anhydrous.

The solvent may be a nonpolar solvent. The solvent may be a nonpolar ether. The solvent may be a non-cyclic ether. The solvent may have a polarity of less than 0.2 as disclosed hereinbefore. The solvent may be a dialkyl ether or an alkyl cycloalkyl ether. The alkyl groups may be branched or straight chains. The alkyl groups may not contain unsaturated groups. Exemplary non-polar solvents include methyl tert-butyl ether, dimethyl ether, diethyl ether, cyclopentyl methyl ether, ethyl acetate and diisopropyl ether.

The initiator may have low solubility in some solvents and the resulting polymer may exhibit higher molecular weights than expected because the effective ratio of monomer in the reactive system may be higher than due to a portion of the initiator charged not being soluble in the reaction solvent.

The methods may comprise contacting monomers with the initiator without a solvent. The polymerization may be conducted in neat monomers. The method may comprise contacting monomers in a solvent system in which the initiator is not soluble. The method may comprise contacting the comonomers with a suspension of solid particles comprising the initiator. The method may comprise contacting neat monomer(s), with solid particles comprising the initiator wherein the solid particles are insoluble in the neat monomer(s). It is desirable to add the initiator, the salt or zwitterions disclosed herein as a liquid or in a liquid carrier. The intiator, the salt or zwitterions disclosed can be heated to a temperature at which it is liquid or at which is dissolves in a carrier or solvent which is then added to the reaction mixture. The temperature for adding the initiator, the salt or zwitterions disclosed to a solvent or carrier or to render it liquid may be higher than the process reaction temperature. It is advantageous to add the initiator as a liquid as this reduces the time for the reaction to initiate the reaction. This reduces or prevents the need for an induction period.

The initiator and the monomers may be contacted at low temperatures ambient temperatures or elevated temperatures. The mixture may be maintained at a temperature of about 30° C. or greater, about 40° C. or greater, about 50° C. or greater, about 60° C. or greater, about 70° C. or greater, about 80° C. or greater or about 100° C. or greater. The mixture may be maintained at a temperature of about 120° C. or less or about 100° C. or less. The mixture may be maintained at a temperature about 20° C. or less, about 15° C. or less, about 10° C. or less, about 5° C. or less, about 0° C. or less, about −10° C. or less, to about −20° C. The method may include the step of removing heat from the mixture to maintain the desired temperature. The method may include changing the temperature of the polymerization mixture over time during the course of the process. The method may include the step of cooling the mixture to maintain the desired temperature. The method may include changing the temperature of the polymerization mixture over time during the course of the process.

The polymerization may be conducted at elevated pressure. This can allow processes to be conducted at temperatures above the boiling point of certain reaction mixture components (e.g. solvents, monomers) and/or may aid in separation of volatile components when the pressurized process stream or reaction vessel is depressurized. The monomers may be contacted with the initiator at a pressure above 1 bar (0.1 MPa), about 2 bar (0.2 MPa) or greater, about 3 bar (0.3 MPa) or greater, about 5 bar (0.5 MPa) or greater, about 10 bar (1.0 MPa) or greater, about 15 bar (1.5 MPa) or greater, about 20 bar (2.0 MPa) or greater, about 30 bar (3.0 MPa) or greater or about 40 bar (4.0 MPa) or greater. The pressure may be about 50 bar (5.0 MPa) or less, about 60 bar (6.0 MPa) or less, about 70 bar (7.0 MPa) or less, about 80 bar (8.0 MPa) or less, about 90 bar (9.0 MPa) or less or about 100 bar (10.0 MPa) or less. The pressure may be applied by pressurizing a reactor headspace in contact with the reaction mixture (e.g. by introducing a pressurized inert gas). The pressure may be applied by heating the mixture in a contained volume. The pressure may be maintained by applying pressure to a hydrostatically filled reaction vessel. Two or more of these approaches may be used. The pressure may be controlled by application of a back-pressure regulator or other pressure relief system.

The methods disclosed herein can be performed in a batch process, continuous process, a hybrid of batch and continuous processes (e.g. fed batch reactions). The method may comprise the step of feeding one or more components to the polymerization mixture over time. Monomers, oligomers, end capping agents, chain extenders, chain transfer agents, or crosslinking agents may be added to the polymerization mixture over time (either continuously, or in one or more discrete additions). The composition of monomers added may be changed over time. Such methods may be characterized in that the polymer composition produced comprises a tapered copolymer or block copolymer.

The method may comprise fed-batch processes and include a step of dissolving or suspending the initiator in a reaction vessel (optionally with a solvent and/or an initial charge of monomers) and then feeding monomers, chain extenders, chain transfer agents, or crosslinking agents into the initial mixture at a controlled rate. Such methods can be beneficial for controlling the exotherm associated with ring opening polymerization of some of the monomers and maintaining safe operating conditions. Certain monomers may be fed at a rate determined, at least in part, by the rate of exotherm observed in the reaction mixture. The monomers may be fed to the process continuously. The monomers may be fed to the process discontinuously (e.g. in discrete additions or at varying rates). The monomers may be fed for a period of time and then ceased at some interval prior to the end of the polymerization.

The methods may comprise continuous flow processes and include a step of continuously adding the initiator to a reaction stream of monomer(s). The combined initiator and monomers stream may then be directed through a continuous reactor with sufficient contact time and temperature profile to produce the desired degree of polymerization. The method may include the addition of more initiator, additional monomers, solvents, or other reaction components at locations along the length of the continuous reactor.

The methods may comprise continuous flow processes and include a step of contacting a reaction stream comprising the initiator and monomer(s) in an extruder. The combined initiator monomer(s) stream may be directed through an extruder with sufficient contact time and temperature profile to consume substantially all the monomer(s). The method may include a reactive extruder with a temperature gradient between the inlet and outlet. The temperature toward the outlet of the extruder may be higher than the temperature of the extruder inlet. In such process no solvent may be present in the reaction stream and the outlet from the extruder comprises molten polymer. The molten polymer stream from the extruder may be fed to a pelletizer to produce pellets of solid polymer. The method may include a reactive extruder coupled to a pre-reactor that feeds an inlet to the extruder. The pre-reactor may comprise a plug flow reactor, a batch or fed batch reactor. Two more pre-reactors may feed a single extruder. A single pre-reactor may feed two or more reactive extruders.

The methods may comprise continuous flow processes and include a step of contacting a reaction stream comprising the initiator, monomer(s) in one or more reactors. The method may include a slurry batch reactor, a slurry continuous stirred tank reactor or a slurry loop reactor. The monomers may be polymerized in a liquid-phase polymerization reactor and/or gas-phase polymerization reactor. As polymer chains develop during polymerization in the reactor, solid particles of solid polymer may be produced in the reactor and the process stream may thereby constitute a slurry. The polymer particles in the slurry may possess one or more melt, physical, rheological, and/or mechanical properties of interest, such as density, melt index (MI), melt flow rate (MFR), comonomer content, molecular weight, crystallinity, and so on. Different properties for the particles may be desirable depending on the application to which the polymer is to be applied. Selection and control of the reaction conditions within the reactor, such as temperature, pressure, chemical concentrations, polymer production rate, initiator type, and so forth, may affect the polymer particle properties.

The disclosed methods may comprise a step of quenching the polymerization reaction. A quenching agent may be added after a specified reaction time, or when the polymer composition has reached a desired molecular weight (the Mn of the formed polymer composition exceeds a predetermined threshold). The quenching agent may be added when substantially all of the monomer(s) have been consumed. Where the method comprises a continuous process utilizing a plug-flow reactor, a quenching agent is added at a particular point along the length of the reactor.

The methods comprise adding an end capping agent to quench the polymerization, as disclosed in PCT application WO2019241596A1, the entirety of which is incorporated herein by reference. The monomers may be polymerized such that the terminal end of the formed polymer chains have carboxylic or carboxylate functional groups. The terminal end groups are reacted with the end capping agent. The endcapping agent may render the formed polymers more stable.

The quenching, endcapping, crosslinking agent or chain extending agent may be added to the reaction mixture in an amount of less than 10 molar equivalents relative to the amount of initiator added to the polymerization process, for example from 0.1 to 10 molar equivalents relative to the amount of the initiator, from 0.1 to 2 molar equivalents, or from 1 to 2 molar equivalents or about 1 molar equivalent.

In methods where a co-monomer is present with the beta-lactone, the co-monomer may be added at the beginning of the process along with the beta-lactone, for example, a batch polymerization may be performed using a defined mixture of beta-lactone and one or more comonomers. The methods may include changing the monomer composition over time by the addition of additional monomers to the polymerization mixture. Such additions may comprise continuous addition of BPL beta-lactone, comonomer(s) or mixtures of beta-lactone and comonomers. Such additions may comprise batch-wise addition of beta-lactone, comonomer(s) or mixtures of beta-lactone and comonomers. Depending on the provided reaction conditions and the relative rates of polymerization of the comonomers under the conditions of the polymerization, such methods may lead to random copolymers, tapered copolymers, or block copolymers.

The methods may include the use of chain extenders, chain transfer agents, and/or crosslinking agents. The methods may comprise contacting beta propiolactone (and optional comonomers) with the initiator in the presence of one or more chain transfer agents. Chain transfer agents are defined as any substance or reagent capable of terminating growth of one polymer chain and initiating polymerization of a new polymer chain. In a living polymerization this may be a reversible process and the net effect is that, on average in the composition, all chains grow at similar rates. Chain transfer agents can be used to control the molecular weight of the produced polymer composition, to optimize the amount of catalyst used, and/or to control the polydispersity of the produced polymer composition. Chain transfer agents can also be used to introduce additional functional groups at chain ends (e.g. for subsequent cross-linking or chain extension reactions, or to impart particular physical properties such as hydrophilicity or hydrophobicity etc.) examples of the latter would include chain transfer agents having radically polymerizable functional groups such as vinyl groups, perfluorinated moieties or siloxyl groups.

Chain transfer agents (CTA) may comprise acidic compounds. Such acidic compounds may be characterized in that their conjugate bases are nucleophilic. The conjugate base of a provided acidic chain transfer agent may have sufficient nucleophilicity to ring open beta propiolactone (or to react with a provided comonomer). Exemplary chain transfer agents include carboxylic acids, sulfonic acids, phosphoric acids, phoshonic acids, phosphinic acids, thiocarboxylic acids, dithiocarboxylic acids, thiols, phenols, and the like. Chain transfer agents may comprise compounds of formula Y′-T-(Y′)ᵣ, where each Y′ is, independently an acidic functional group (or a salt formed by deprotonation of such a group), -T- is a multivalent moiety, and r is 0 or an integer between 1 and 10. Y′ may be, independently selected from a carboxylic acid, sulfonic acid, phosphoric acid, phoshonic acid, phosphinic acid, thiocarboxylic acid, dithiocarboxylic acid, a thiol, and a phenolic-OH group, (or an anion formed by deprotonation of any of these). The chain transfer agents may comprise molecules having more than one functional group capable of acting as a chain transfer agent (dicarboxylic acids, tricarboxylic acids). The chain transfer agents may comprise carboxylic acids, such as formic acid, acetic acid, propionic acid, 3-hydroxypropionic acid, 3-hydroxybutanoic acid, lactic acid, benzoic acid, acrylic acid, and methacrylic acid. The chain transfer agent may comprise a phenol, a thiol or a derivative thereof.

The CTA may be present at the beginning of the reaction, or it may be added during the polymerization process (either continuously at a constant or variable rate, or by portion-wise addition). The addition of CTA may be used to control the molecular weight distribution of the polymer composition. The CTA may be added portion-wise at one or more time points in the reaction to provide a polymer composition with a bi- or multi-modal molecular weight distribution. The CTA may be added continuously during at least part of the polymerization process to provide a polymer composition with a broadened molecular weight distribution. Where the CTA is added at the beginning of the polymerization reaction, the result is a polymer composition with a narrow PDI. The chain transfer agent may be provided at a molar ratio of from about 1:1 to about 10,000:1 relative to the polymerization initiator, or from about 1:1 to about 10:1, e.g. 1:1, 2:1, 3:1, 4:1, 5:1, 6:1, 8:1 or 10:1 or from about 10:1 to about 100:1, (20:1, 30:1, 40:1, 50:1, 75:1, or 100:1), or about 100:1 to about 1,000:1, (200:1, 300:1, 400:1, 500:1, 750:1, or 1000:1)

The polymerization methods may be integrated into a process for production of beta lactones. Such integrated processes can have advantages in terms of energy efficiency and can lead to higher quality polymer products due to reduced introduction of water, oxygen or other impurities. The methods may include a step of reacting ethylene oxide with carbon monoxide to form beta propiolactone. Exemplary catalysts and methods for such processes are described in Published Patent Applications: WO2013/063191, WO2014/004858, WO2003/050154, WO2004/089923, WO2012/158573, WO2010/118128, WO2013/063191, and WO2014/008232; in U.S. Pat. Nos. 10,662,283, 5,359,081 and 5,310,948 and in the publication “Synthesis of beta-Lactones” J. Am. Chem. Soc., vol. 124, 2002, pages 1174-1175, the entire contents of each of which is incorporated herein by reference. The methods may comprise the steps of: contacting ethylene oxide with carbon monoxide in the presence of a carbonylation catalyst and a solvent to provide reaction stream comprising beta propiolactone; separating a product stream comprising beta lactone from the reaction stream and feeding the beta lactone-containing reaction stream into a polymerization reactor and contacting it with an anionic initiator to provide a second reaction stream containing a biodegradable polyester. Such integrated carbonylation/polymerization processes may be characterized in that substantially all carbonylation catalyst is removed from the reaction stream comprising beta propiolactone prior to feeding the stream into the polymerization reactor. Such integrated carbonylation/polymerization processes are characterized in that at least a portion of the solvent in which the carbonylation process is performed is present in the reaction stream comprising beta propiolactone and is fed into the polymerization reactor. The method may comprise separating the solvent from the second reaction stream containing the polymer. The method may comprise recycling the separated solvent back to the carbonylation reaction. The processes may be characterized in that the reaction stream comprising beta propiolactone contains residual ethylene oxide and the beta propiolactone ethylene oxide mixture is fed into the polymerization reactor. The ethylene oxide may comprise a comonomer in the BPL polymerization.

The methods described herein include a step of contacting beta-lactone and optional comonomers with polymerization initiators that are one or more salts of one or more one or more onium cations and one or more phosphate anions, one or more zwitterions having one or more phosphate anions and onium cations or one or more carboxylate salts of an onium cation, which may be generated in-situ. The carboxylate salts of an onium cation may comprise any compounds having the residue of an onium cation and a carboxylate group in a salt form. The carboxylate portion may have a hydrocarbyl group bonded to the carbonyl group and which may be optionally substituted. The hydrocarbyl group may be an alkyl, aryl or alkaryl group. The alkylgroup may be a C₁ₜₒ₂₀ straight or branched chain optionally substituted with a substituent which does not interfere in the ability of the salt to function as an anionic intiator. The hydrocarbyl group may be a C_{1 to 8} straight or branched alkyl group which may be optionally substituted, a C_{1 to 4} straight or branched alkyl group, a methyl or ethyl group or a methyl group. The onium cation can be any onium cation which forms a salt with the carboxylate, which does not interfere with carboxylate forming an anion which can initiate anionic polymerization. Exemplary oniums contain one or more of the onium cations contain nitrogen, phosphorus, sulfur, antimony or arsenic. Exemplary oniums contain one or more of nitrogen, phosphorus or sulfur. The oniums may contain one or both of nitrogen and phosphorus. The oniums may contain nitrogen. The carboxylate salts of onium ions may correspond to the formula:

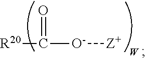

wherein R²⁰ is separately in each occurrence hydrocarbyl group which may be optionally substituted, w is separately in each occurrence a number of 1 or greater and Z is an onium cation as described herein. R²⁰ may be multivalent having w valences. R²⁰ may be an alkyl, aryl or alkaryl group. R²⁰ may be a C₁ₜₒ₂₀ straight or branched chain optionally substituted with a substituent which does not interfere in the ability of the salt to function as an anionic intiator. R²⁰ may be a C₁₋₈ straight or branched alkyl group which may be optionally substituted, a C₁₋₄ straight or branched alkyl group, a methyl or ethyl group or a methyl group. A may be separately in each occurrence polymer chain comprising units derived from a ring opened betalactone. w may be separately in each occurrence a number of 2 or greater. W may be 1 to 6. W may be 2 to 6 or 2 to 3. The initiators may comprise organic “onium cations” as disclosed herein. The disclosed salts and zwitterions may function as intiators, generate intiators and function to accelerate the polymerization.

Methods disclosed may comprise contacting monomers with the initiator in the presence of a complexing agent. Addition of complexing agents may improve the methods by increasing the rate of the polymerization, enhancing the yield of polymer, or may result in improved polymer properties through control of properties such as molecular weight or polydispersity. Exemplary complexing agents comprise crown ethers, and other macro polyheterocycles containing rings with a plurality of heteroatoms of —O—, —NR—, and —S—. Complexing agents comprise crown ethers. Exemplary crown ethers include, but are not limited to, those described in the thesis titled APPLICATIONS OF CROWN ETHERS IN INDUSTRIAL ANIONIC POLYMERIZATIONS (Thomas Newton Montgomery, Jr.; Georgia Institute of Technology, December 1977) the entire content of which is incorporated herein by reference. Exemplary complexing agents include: 1,4,7,10,13,16-hexaoxacyclooctadecane (18-crown-6); 1,4,7,10,13-pentaoxacyclopentadecane (15-crown-5) 1,4,7,10-tetraoxacyclododecane (12-crown-4), dibenzo 18-crown-6, 21-crown-7, and derivatives or mixtures of any of these. The complexing agent may comprise 15-crown-5 or 12-crown-4. Crown ethers may be selected on the basis of its ability to effectively form a complex with the cationic functional group present in the zwitterionic polymerization initiator used in the process. Complexing agents comprise macro heterocycles comprising heteroatoms other than oxygen. Complexing agents may comprise crown ethers where one or more oxygen atoms is replaced by a nitrogen or sulfur atom. The complexing agents may comprise aza-crown ethers, such as 4,7,13,16,21-Pentaoxa-1,10-diazabicyclo[8.8.5] tricosane; 1,4,8,12-Tetraazacyclopenta-decane; and 1,4,10,13-Tetraoxa-7,16-diazacyclooctadecane. The complexing agents may comprise those described in U.S. Pat. No. 3,890,278, the entirety of which is incorporated herein by reference. The complexing agents may comprise thia-crown ethers.

The complexing agent may be introduced at the beginning of the polymerization process, or at any later time. The complexing agent may be added at the same time as the initiator. The complexing agent may be provided as a mixture or solution with the polymerization initiator and the mixture may be fed to the reaction as described above for addition of the initiator. The complexing agent may be used, in a quantity ranging from about a 1:100 to about a 100:1 molar ratio relative to the polymerization initiator, 1:10 to 10:1, 1:2 to 2:1 relative to the zwitterionic polymerization initiator. The chain transfer agent may be utilized in the method, the complexing agent may be provided at a molar ratio relative to the CTA ranging from 1:10 to 10:1, 1:5 to 5:1, or 1:2 to 2:1.

Where w is two or greater the polymers formed may be chain extended by compounds having two or more epoxide and or lactone groups. The chain extension and or crosslinking may be performed under conditions wherein epoxide and or lactone groups ring open as disclosed herein.

### Embodiments

1. A polymer comprising one or more polymer chains having ring opened betalactone units and having on one end of a portion of the chains a residue of a phosphate anion covalently bonded to the one end of the polymer chains and on the other end of a portion of the chains is one or more onium containing cations.

2. A polymer according to Embodiment 1 wherein the onium cations contain one or more of nitrogen, phosphorus, sulfur, antimony or arsenic.

3. A polymer according to Embodiment 1 or 2 wherein the onium cations comprise one or more quaternary nitrogen containing cations or quaternary phosphonium containing cations.

4. A polymer according to any of the preceding Embodiments wherein yhe one or more quaternary nitrogen containing cations are amines having four carbon groups wherein two or more of the carbon groups may form one or more aromatic or non-aromatic ring structures which may optionally contain one or more heteroatoms.

5. A polymer according to any of the preceding Embodiments wherein the one or more nitrogen containing cations comprises one or more ammonium, amidinium, and guanidinium cations or an onium cation based on a nitrogen-containing heterocycle.

6. A polymer according to any of the preceding Embodiments wherein the one or more nitrogen containing cations comprises one or more onium cations based on a nitrogen-containing heterocycle comprising optionally substituted pyridinium, imidazolium, pyrrolidinium, or piperidinium.

7. A polymer according to any of the preceding Embodiments wherein the one or more nitrogen containing cations comprises one or more optionally substituted imidazoliums.

8. A polymer according to any of the preceding Embodiments wherein the one or more nitrogen containing cations comprises one or more of one or more quaternary ammonium cations or one or more guanidinium cations.

9. A polymer according to any of the preceding Embodiments wherein the one or more quaternary ammonium cations are one or more tetraalkyl ammonium anions or N-alkyl substituted pyridinium, imidazolium, pyrrolidinium, or piperidinium cations.

10. A polymer according to according to any of the preceding Embodiments wherein the one or more quaternary ammonium cations correspond to the formula

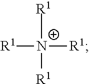

wherein R¹ is separately in each occurrence a carbon containing group and wherein two or more of R¹ may form one or more aromatic or non-aromatic ring structures which may optionally contain one or more heteroatoms.

11 A polymer according to according to any of the preceding Embodiments wherein the one or more one or more guanidinium cations correspond to the formula

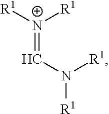

wherein R¹ is separately in each occurrence a carbon containing group and wherein two or more of R¹ may form one or more aromatic or non-aromatic ring structures which may optionally contain one or more heteroatoms.

12. A polymer according to any of the preceding Embodiments wherein the one or more imidazolium cations correspond to the formula

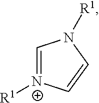

wherein R¹ is separately in each occurrence a a carbon containing group.

13. A polymer according to any of the preceding Embodiments wherein the one or more quaternary ammonium cations are one or more tetraalkyl ammonium anions or N-alkyl substituted imidazolium.

14. A polymer according to any of the preceding Embodiments wherein the one or more phosphorus containing cations are one or more quaternary phosphonium anionscations.

15. A polymer according to any of the preceding Embodiments wherein the one or more quaternary phosphonium cations correspond to the formula:

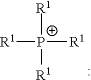

wherein R¹ is separately in each occurrence a carbon containing group wherein two or more of R¹ may form one or more aromatic or non-aromatic ring structures which may optionally contain one or more heteroatoms.

16. A polymer according to any one of the preceding Embodiments wherein the phosphate anion corresponds to the formula;

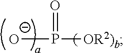

wherein R² is separately in each occurrence an optionally substituted carbon containing group; a is separately in each occurrence 1, 2 or 3; and b is separately in each occurrence 0, 1 or 2; wherein the sum of a and b is 3.

17. A polymer according to any one of the preceding Embodiments wherein the phosphate anion corresponds to the formula

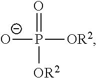

wherein R² is separately in each occurrence a carbon containing group.

18. A polymer according to any one of the preceding Embodiments wherein the one or more polymer chains have the residue of an end capping agent or quenching agent on a portion of the ends of the chains.

19. A polymer according to any of the preceding Embodiments wherein the end capping agent is an organohalide, organosulfonate, a haloalkyl silane, an aniline derivative, a phosphate derivative, and an isophthalic acid derivative.

20. A polymer according to any one of the preceding Embodiments wherein the polymer contains a comonomer which polymerizes with ring opened beta propiolactone and/or substituted betapropiolactone.

21. A polymer according to any one of the preceding Embodiments wherein the comonomers are one or more of caprolactones, lactides, epoxides, oxetanes, cyclic anhydrides, cyclic ethers, lactams, episulfides, aziridines, (meth)acrylates, valerolactones, butyrolactone, glycolides and substituted glycolides.

22. A polymer according to any one of the preceding Embodiments wherein the comonomers are one or more epoxides.

23. A polymer according to any one of the preceding Embodiments wherein the polymers correspond to one of the formulas:

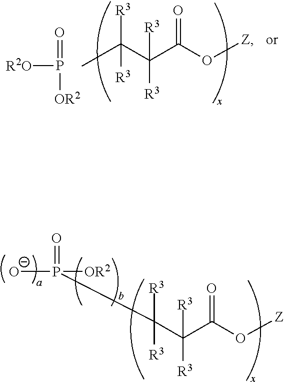

wherein R² is separately in each occurrence an optionally substituted carbon containing group, R³ is separately in each occurrence hydrogen, a carbon containing group; which may optionally contain one or more heteroatoms and/or substituents; a is separately in each occurrence 1, 2 or 3; b is separately in each occurrence 0, 1 or 2; x is separately in each occurrence a real number of greater than 1; and, Z is separately in each occurrence hydrogen, the residue of an onium cation, the residue of a quenching agent, a capping agent, or hydrogen.

24. A polymer according to any one of the preceding Embodiments wherein a portion of the polymer chains may have a carboxylate group on the end of some of the chains.

25. A polymer according to any one of the preceding Embodiments wherein a portion of the polymer chains may have a carboxylate group on the end of some of the chains which correspond to the formula:

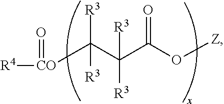

wherein R² is separately in each occurrence an optionally substituted carbon containing group, R³ is separately in each occurrence hydrogen, a carbon containing; which may optionally contain one or more heteroatoms and/or substituents, R⁴ is independently in each occurrence a carbon containing group which may contain a heteroatom or be substituted with a functional group; a is separately in each occurrence 1, 2 or 3; b is separately in each occurrence 0, 1 or 2; x is separately in each occurrence a real number of greater than 1; and, Z is separately in each occurrence hydrogen, the residue of an onium cation, the residue of a quenching agent, an endcapping agent or hydrogen.

26. A polymerizable composition comprising:
a. one or more of beta propiolactone and/or substituted betapropiolactones; and
b. one or more salts of one or more one or more onium cations and one or more phosphate anions or one or more zwitterions having one or more phosphate anions and onium cations.

27. A polymerizable composition according to Embodiment 26 wherein the onium cations contain one or more of nitrogen, phosphorus, sulfur, antimony or arsenic.

28. A polymerizable composition according to Embodiment 26 or 27 wherein the onium cations comprise one or more quaternary nitrogen containing cations or quaternary phosphonium containing cations.

29. A polymerizable composition according to any one of Embodiments 26 to 28 wherein the one or more quaternary nitrogen containing cations or quaternary phosphonium cations are one or more tetraalkyl ammonium anions or tetraalkyl phosphonium anions.

30. A polymerizable composition according to any one of Embodiments 26 to 28 wherein the one or more quaternary nitrogen containing cations are tetrahydrocarbyl amines wherein two or more of the hydrocarbyl groups may form one or more aromatic or non-aromatic ring structures which may optionally contain one or more heteroatoms.

31. A polymerizable composition according to any one of Embodiments 26 to 30 wherein the one or more quaternary nitrogen containing cations comprises one or more ammonium, amidinium, and guanidinium cations, or an onium cation based on a nitrogen-containing heterocycle.

32. A polymerizable composition according to any one of Embodiments 26 to 31 wherein the one or more quaternary nitrogen containing cations comprises one or more of an onium cation based on a nitrogen-containing heterocycle comprising optionally substituted pyridinium, imidazolium, pyrrolidinium, or piperidinium.

33. A polymerizable composition according to any one of Embodiments 26 to 32 wherein the one or more quaternary nitrogen containing cations comprises one or more optionally substituted imidazoliums.

34. A polymerizable composition according to any one of Embodiments 26 to 32 wherein the one or more quaternary nitrogen containing cations are one or more quaternary ammonium cations which correspond to the formula

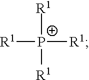

wherein R¹ is separately in each occurrence a carbon containing group wherein two or more of R¹ may form one or more aromatic or non-aromatic ring structures which may optionally contain one or more heteroatoms.

35. A polymerizable composition according to any one of Embodiments 26 to 34 wherein the one or more quaternary nitrogen containing cations are one or more guanidinium cations which correspond to the formula:

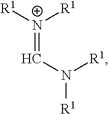

wherein R¹ is separately in each occurrence a carbon containing group wherein two or more of R¹ may form one or more aromatic or non-aromatic ring structures which may optionally contain one or more heteroatoms.

34b. A polymerizable composition according to any one of Embodiments 25 to 33 wherein the one or more quaternary ammonium cations are one or more tetraalkyl ammonium anions or N-alkyl substituted pyridinium, imidazolium, pyrrolidinium, or piperidinium cations.

35b. A polymerizable composition according to any one of Embodiments 25 to 34 wherein the one or more imidazolium cations correspond to the formula

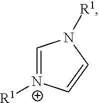

wherein R¹ is separately in each occurrence a carbon containing group which may contain a heteroatom.

36. A polymerizable composition according to any one of Embodiments 26 to 35 wherein the one or more quaternary ammonium cations are one or more tetraalkyl ammonium or N-alkyl substituted imidazolium cations.

37. A polymerizable composition according to any one of Embodiments 26 to 36 wherein the one or more quaternary phosphonium anions cations are one or more tetraalkyl phosphonium cations.

38. A polymerizable composition according to any one of Embodiments 26 to 34 wherein the one or more quaternary phosphonium cations correspond to the formula:

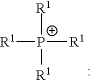

wherein R¹ is separately in each occurrence a carbon containing group wherein two or more of R¹ may form one or more aromatic or non-aromatic ring structures which may optionally contain one or more heteroatoms.

39. A polymerizable composition according to any one of Embodiments 26 to 38 wherein the one or more quaternary phosphonium cations are tetra alkyl phosphonium cations.

40 A polymerizable composition according to any one of Embodiments 26 to 39 wherein the phosphate anion corresponds to the formula;

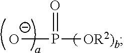

wherein R² is separately in each occurrence an optionally substituted carbon containing group;
a is separately in each occurrence 1, 2 or 3; and
b is separately in each occurrence 0, 1 or 2; wherein the sum of a and b is 3.

41. A polymerizable composition according to any one of Embodiments 26 to 40 wherein the one or more salts of one or more onium cations and one or more phosphate anions corresponds to the formula

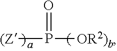

wherein R² is separately in each occurrence an optionally substituted carbon containing group; Z′ is separately in each occurrence an onium cation; a is separately in each occurrence 1, 2 or 3; and b is separately in each occurrence 0, 1 or 2; wherein the sum of a and b is 3.

42. A polymerizable composition according to any one of Embodiments 26 to 41 wherein the one or more salts of one or more quaternary nitrogen containing cations or quaternary phosphonium cations and one or more phosphate anions corresponds to one of the formulas

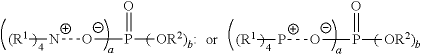

wherein R¹ is separately in each occurrence a carbon containing group wherein two or more of R¹ may form one or more aromatic or non-aromatic ring structures which may optionally contain one or more heteroatoms; and, wherein R² is separately in each occurrence an optionally substituted carbon containing group; a is separately in each occurrence 1, 2 or 3; and b is separately in each occurrence 0, 1 or 2; wherein the sum of a and b is 3.

43. A polymerizable composition according to any one of Embodiments 26 to 42 wherein the one or more salts of one or more quaternary nitrogen containing cations or quaternary phosphonium cations and one or more phosphate anions corresponds to one of the formulas

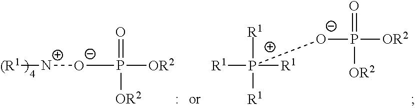

wherein R¹ is separately in each occurrence a carbon containing group wherein two or more of R¹ may form one or more aromatic or non-aromatic ring structures which may optionally contain one or more heteroatoms; and, wherein R² is separately in each occurrence a carbon containing group.

44. A polymerizable composition according to any one of Embodiments 26 to 43 wherein the one or more salts of one or more one or more quaternary nitrogen containing cations and one or more phosphate anions corresponds to the formula

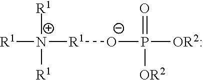

wherein R¹ is separately in each occurrence a carbon containing group wherein two or more of R¹ may form one or more aromatic or non-aromatic ring structures which may optionally contain one or more heteroatoms; and, R² is separately in each occurrence an optionally substituted carbon containing group.

45. A polymerizable composition according to any one of Embodiments 26 to 44 wherein the one or more zwitterions salts of one or more quaternary nitrogen containing cations and one or more phosphate anions correspond to the formula

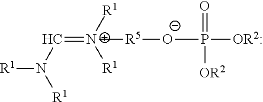

wherein R¹ is separately in each occurrence a carbon containing group wherein two or more of R¹ may form one or more aromatic or non-aromatic ring structures which may optionally contain one or more heteroatoms; and, R² is separately in each occurrence an optionally substituted carbon containing group.

46. A polymerizable composition according to any one of Embodiments 26 to 45 wherein the one or more salts of one or more one or more quaternary nitrogen containing cations and one or more phosphate anions corresponds to the formula

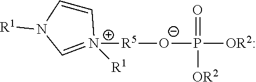

wherein R¹ is separately in each occurrence a carbon containing group wherein two or more of R¹ may form one or more aromatic or non-aromatic ring structures which may optionally contain one or more heteroatoms; and, R² is separately in each occurrence an optionally substituted hydrocarbyl group.

47. A polymerizable composition according to any one of Embodiments 26 to 46 wherein the zwitterion corresponds to the formula

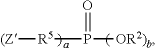

wherein R² is separately in each occurrence an optionally substituted carbon containing group; R⁵ is separately an optionally substituted carbon containing moiety; Z′ is separately in each occurrence an onium cation; a is separately in each occurrence 1, 2 or 3; and b is separately in each occurrence 0, 1 or 2; wherein the sum of a and b is 3.

48. A polymerizable composition according to any one of Embodiments 26 to 47 wherein the zwitterions to one of the formulas correspond

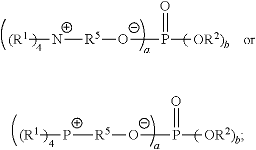

wherein R¹ is separately in each occurrence a carbon containing group wherein two or more of R¹ may form one or more aromatic or non-aromatic ring structures which may optionally contain one or more heteroatoms; and, wherein R² is separately in each occurrence an optionally substituted carbon containing group; R⁵ is separately an optionally substituted carbon containing moiety; a is separately in each occurrence 1, 2 or 3; and b is separately in each occurrence 0, 1 or 2, wherein the sum of a and b is 3.

49. A polymerizable composition according to any one of Embodiments 26 to 48 wherein the one or more zwitterions of one or more quaternary nitrogen containing cations or quaternary phosphonium cations and one or more phosphate anions corresponds to one of the formulas

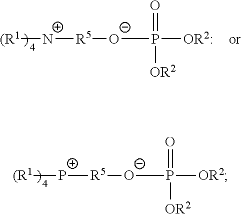

wherein R¹ is separately in each occurrence a carbon containing group wherein two or more of R¹ may form one or more aromatic or non-aromatic ring structures which may optionally contain one or more heteroatoms; wherein R² is separately in each occurrence an optionally substituted carbon containing group; and, R⁵ is separately an optionally substituted carbon containing moiety.

50. A polymerizable composition according to any one of Embodiments 26 to 49 wherein the one or more zwitterions containing one or more one or more quaternary nitrogen containing cations and one or more phosphate anions corresponds to the formula:

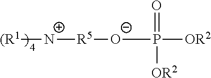

wherein R¹ is separately in each occurrence a carbon containing group wherein two or more of R¹ may form one or more aromatic or non-aromatic ring structures which may optionally contain one or more heteroatoms; and, R² is separately in each occurrence an optionally substituted hydrocarbyl group and, R⁵ is separately an optionally substituted carbon containing moiety.

51. A polymerizable composition according to any one of Embodiments 26 to 50 wherein the one or more zwitterions of one or more one or more quaternary nitrogen containing cations and one or more phosphate anions corresponds to the formula:

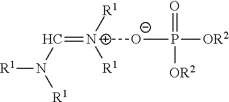

wherein R¹ is separately in each occurrence a carbon containing group wherein two or more of R¹ may form one or more aromatic or non-aromatic ring structures which may optionally contain one or more heteroatoms; and, R² is separately in each occurrence an optionally carbon containing group and, R⁵ is separately an optionally substituted carbon containing moiety.

52. A polymerizable composition according to any one of Embodiments 26 to 51 wherein the one or more zwitterions of one or more one or more quaternary nitrogen containing cations and one or more phosphate anions correspond to the formula

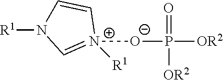

wherein R¹ is separately in each occurrence a carbon containing group wherein two or more of R¹ may form one or more aromatic or non-aromatic ring structures which may optionally contain one or more heteroatoms; and, R² is separately in each occurrence an optionally substituted carbon containing group and, R⁵ is separately an optionally substituted carbon containing moiety.

53. A polymerizable composition according to any one of Embodiments 26 to 52 comprising one or more comonomers which copolymerize with the one or more of beta-lactone.

54. A polymerizable composition according to any one of Embodiments 26 to 53 comprising one or more of chain transfer agents, chain extenders, quenching agents and end capping agents.

55. A polymerizable composition according to any one of Embodiments 26 to 54 wherein the mole ratio of the one or more of beta-lactone to the one or more one or more salts of one or more onium cations and one or more phosphate anions or one or more zwitterions having one or more phosphate anions and onium cations. is from about 10 to 1 to about 1,000,000 to 1.

56. A polymerizable composition according to any one of Embodiments 26 to 55 wherein the end capping agent is an organohalide, organosulfonate, a haloalkyl silane, an aniline derivative, a phosphate derivative, a boric derivative, and an isophthalic acid derivative.

57. A polymerizable composition according to any one of Embodiments 26 to 56 wherein the end-capping or quenching agent is present in an amount of less than 10 molar equivalents relative to the amount of one or more salts of one or more onium cations and one or more phosphate anions or one or more zwitterions having one or more phosphate anions and onium cations.

58. A polymerizable composition according to any one of Embodiments 26 to 57 wherein comonomers are one or more of caprolactones, lactides, epoxides, oxetanes, cyclic anhydrides, cyclic ethers, lactams, episulfides, aziridines, (meth)acrylates, valerolactones, butyrolactone, glycolides and substituted glycolides.

59. A polymerizable composition according to any one of Embodiments 26 to 58 wherein comonomers are one or more epoxides.

60. A method comprising contacting the elements of the polymerizable composition of any one of Embodiments 26 to 59 under conditions to prepare one or more polymers comprising one or more polymer chains having ring opened beta-lactone units.

61. A method according to Embodiment 60 wherein the elements are contacted at a temperature of from about 30° C. to about 120° C.

62. A method according to Embodiment 60 or 61 wherein the elements are contacted at a pressure of between about 1 bar (0.1 MPa) and about 20 bar (2.0 MPa).

63. A method according to any one of Embodiments 60 to 62 wherein the elements are contacted for a time sufficient to consume substantially all of the one or more of betalactones and comonomers.

64. A method according to any one of Embodiments 60 to 63 wherein after a specified reaction time, or when the polymer composition has reached a desired molecular weight, a quenching agent is added to terminate the polymerization reaction.

65. A method according to any one of Embodiments 60 to 64 wherein the quenching agent is one or more of mineral acids, organic acids or acidic resins or solids.

66. A method according to any one of Embodiments 60 to 65 wherein after a specified reaction time, or when the polymer composition has reached a desired molecular weight an endcapping agent is added.

67. A method according to Embodiment 66 wherein the end capping agents comprises one or more electrophilic organic compounds.

68. A method according to Embodiment 66 or 67 wherein the end capping agents comprise one or more one or more of an organohalide, organosulfonate, a haloalkyl silane, an aniline derivative, a phosphate derivative, a boric derivative, and an isophthalic acid derivative.

69. A method according to any one of Embodiments 66 to 68 wherein the end-capping agent is present in an amount of less than 10 molar equivalents relative to the amount of one or more salts of one or more onium cations and one or more phosphate anions.

70. A method according to any one of Embodiments 60 to 69 wherein the elements are contacted in a solvent which is a non-polar solvent or a polar solvent.

71. A method according to Embodiment 70 wherein the solvent is a non-polar ether, an alkanol, or an acetate.

72. A method according to Embodiment 70 to 72 wherein the solvent exhibits a polarity of less than 0.2.

73. A method according to any one of Embodiments 70 to 73 wherein the solvent is a non-cyclic ether, or a cyclic ether, a lower alkanol, or an alkyl acetate.

74. A method according to any one of Embodiments 70 to 73 wherein the solvent is methyl tert-butyl ether, dimethyl ether, diethyl ether, cyclopentyl methyl ether, ethyl acetate diisopropyl ether,

75. A method according to any one of Embodiments 60 to 74 wherein the polymer formed is contacted with a polyepoxide or a polylactone to under conditions such that the polymer is crosslinked through the terminal groups of the polymer.

75. A method according to any one of Embodiments 60 to 75 wherein the polymer formed has carboxylate groups and/or phosphate groups at one end of the chains formed.

76. A method according to any one of Embodiments 60 to 75 wherein a portion of the end groups are phosphate groups.

77. A method according to any one of Embodiments 60 to 76 wherein a portion of the end groups are one or more nitrogen containing or phosphorus containing cations.

### Examples

The following examples are merely illustrative and are not meant to limit any aspects of the present disclosure in any way.

### Phosphate Salts Utilized in the Examples

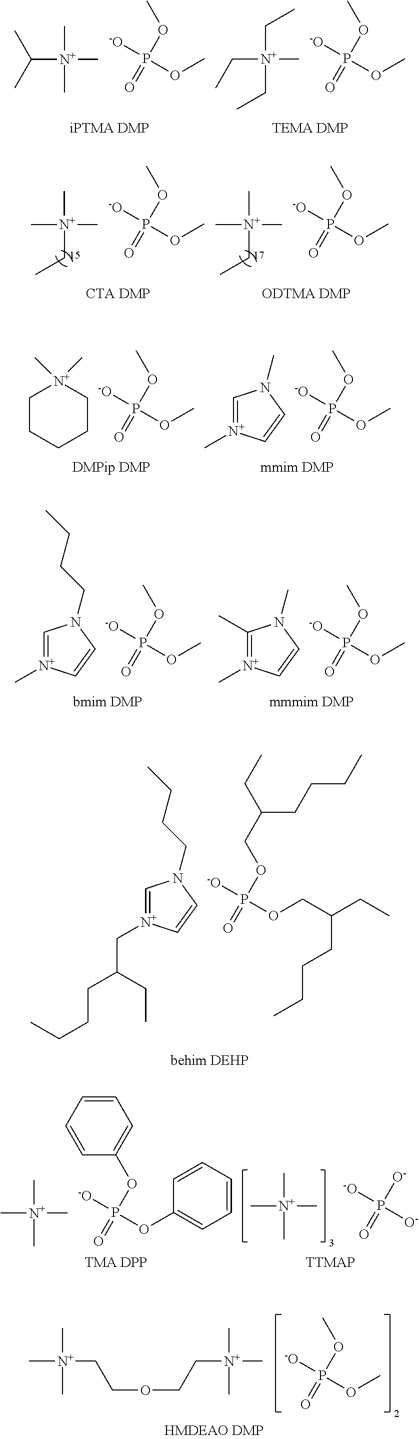

### Biobased Phosphate Zwitterion Utilized in the Examples

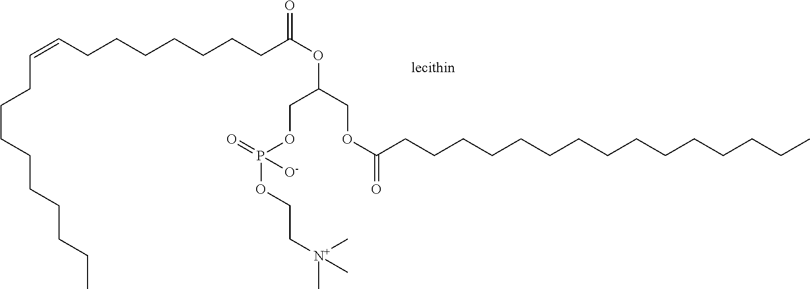 [SMILES: CCCCCCCCC/C=C\CCCCCCCC(=O)OC(COC(=O)CCCCCCCCCCCCCCC)COP(=O)([O-])OCC[N+](C)(C)C]

Synthesis with Salt of Trimethyl Phosphate and a Tertiary Amine.

Synthesis of isopropyl-trimethylammonium dimethyl phosphate [iPTMA DMP]. In a 100 mL round bottom flask equipped with stir bar, dimethyl isopropylamine [DMIPA; 20 mL; 164 mmol] and trimethyl phosphate [TMP; 19.1 mL; 164 mmol] are combined. The flask is equipped with a reflux condenser and heated to 110° C. overnight. The reaction is complete when the solution no longer refluxes. After heating for 14 h, the solution is cooled to room-temperature to yield a white solid. The solution is recrystallized from acetone at −20° C. to yield a white solid, filtered quickly and dried en vacuo overnight to yield a hydroscopic and colorless/white semi-solid, 31 g [90%] [Tₘ=21° C.].

Synthesis of 1-butyl, 3-(2-ethylhexyl) imidazolium bis(2-ethylhexyl) phosphate [behim DEHP]. In a 50-mL round bottom flask, 10 g of tris(2-ethylhexyl) phosphate and 2.8 g of 1-butylimidazole is combined. The reaction is heated to 150° C. overnight [13h] to yield a yellow liquid, 12.7 g, quantitative yield. The ionic liquid is used as it without further purification.

Synthesis of tetramethylammonium diphenyl phosphate [TMA DPP]. Tetramethylammonium hydroxide in water [˜25% in water; 2.5 mL] are added to a 2-neck 50-mL round bottom flask equipped with a stir bar. The flask is then chilled in an ice bath to 0° C., Then, 1.7 g of diphenyl phosphate, dissolved in minimal water [˜10 mL], is added dropwise. Once all the acid is added, the solution is warmed to room-temperature. After 1 h, the flask is emerged in an oil bath at 35° C. with a low air flow overnight to evaporate the water to yield a white powder, ˜2 g [Tₘ=78° C.].

TABLE 1
Ionic liquid properties

| ionic liquid | | Tm^{a} | Tc^{a} | TGA^{b} | | |
|---|---|---|---|---|---|---|
| [IL] | Physical State | [° C.] | [° C.] | [5%][° C.] | TGA^{b} residue | Solubility^{c} |
| iPTMA DMP | solid | 21 | −17 | 207 | >21% | Water, alcohol |
| TEMA DMP | Liquid/solid | 50 | −3 | 220 | >20% | Water, alcohol |
| CTA DMP | Solid | 43 | 39 | 207 | >2% | Water, alcohol |
| | | 60 | 22 | | | |
| ODTMA DMP | Solid | 51 | 22 | 219 | >2% | Water, alcohol, |
| | | 95 | 75 | | | THF |
| | | 120 | 102 | | | |
| DMPip DMP | Liquid/solid | 94 | 53 | 231 | >13% | Water, alcohol |
| Mmim DMP | Liquid | NA | NA | 244 | >24% | Water, alcohol |
| Bmim DMP | Liquid | NA | NA | 241 | 14% | Water, alcohol |
| Mmmim DMP | Solid | 87 | 92 | 240 | >20% | Water, ROH |
| | | 96 | 10 | | | |
| Behim DEHP | Liquid | NA | NA | | | MTBE, THF, |
| | | | | | | alcohol |
| TMA DPP | Solid | [78; | NA | 270 | 5 | Water, alcohol |
| | | Tg] | | | | |
| TTMAP | Solid | 88 | 100 | 131 | 15 | Water, alcohol |
| | | 116 | 55 | | | |
| HMDEDA | Solid | NA | NA | 245 | 22 | Water, alcohol, |
| DMP | | | | | | THF |

^{a}Determined by differential scanning calorimetry [DSC; 10° C./min]
^{b}Determined by thermogravimetric analysis [TGA; 10° C./min under N_{2(g)}]
^{c}Solubility tested at 1 mg/mL concentration at room temperature.

Tertiary amines readily reacted with trimethyl phosphate in the bulk to prepare quaternary ammonium phosphates. These solids are isolated as low-melting point solids [Table 1]. Quaternary ammonium phosphates are soluble in only water and alcohol solutions, except for octadecyl-trimethylammonium dimethyl phosphate [ODTMA DMP], which also dissolved in tetrahydrofuran [THF] solution

Imidazolium-based ionic liquids are also prepared using the same methodology for quaternary ammonium phosphates. Unlike tertiary amines, imidazolium derivatives could react with tris(2-ethylhexyl) phosphate to make the corresponding imidazolium phosphate salts, such as 1-butyl, 3-(2-ethylhexyl) imidazolium and bis(2-ethylhexyl) phosphate [behim DEHP]. These salts exhibit similar solubility to quaternary ammonium phosphates. Surprisingly, behim DEHP does not dissolve in water, but is readily soluble in methyl tert-butyl ether [MTBE], an ideal solvent for beta-lactone polymerization. 1,3-Disubstituted imidazolium phosphates are liquids at room-temperature, an ideal feature for a polymerization additive as well by facilitated the addition of the reagent without the need of heat or solvent.

Finally, phosphate salts are prepared via acid/base reaction. This is the conventional method for preparing tetraalkylammonium salts with phosphoric or carboxylic acids via dehydration of tetramethylammonium hydroxide and the organic acid. This can be used to prepare monobasic ammonium phosphate salts, such as tetramethylammonium diphenyl phosphate [TMA DPP] or tribasic ammonium phosphate salts, such as tris(tetramethylammonium) phosphate [TTMAP]. These salts are isolated as white solids that do not melt, they degrade prior to melting.

### Polymerization with Ionic Liquids Examples

Example 1 The ionic liquid, ODTMA DMP [155 mg; 0.32 mmol], is added to a 20 mL scintillation vial equipped with a stir bar. Then 1 mL of beta-propiolactone [bPL; 16 mmol] in 10 mL of methyl tert-butyl ether [MTBE] is added to the vial. The reaction is heated at 40° C. and a white powder precipitated from the solution in less than 20 min. After 1 h, the beta-propiolactone is greater than 99% consumed, according to GC-TCD analysis of the reaction solvent. To workup the reaction, the solid is filtered, collected, and dried en vacuo overnight to yield a white fluffy solid, 1.01 g [89%; Mₙ (GPC)=45800 g/mol, PDI=2.2].

Ionic Liquids as Polymerizing Agents for Polypropiolactone from bPL

To test the effectiveness of structure-property relationship of phosphate-based ionic liquids as polymerizing agents for beta-propiolactone, reactions are performed under uniform conditions [1.6M bPL in MTBE at 40° C.] solvent across a range of monomer to ionic liquid ratios. A “polymerizing agent” in this situation could be defined as a catalyst, an initiator, or both via a reversible reaction that does not fully consume the phosphate catalyst. Methyl t-butyl ether (MTBE) is chosen based on the efficacy of betapropiolactone in MTBE solvent using tetramethylammonium acetate as an initiator under similar conditions.

TABLE 2
Conditions and results of bPL polymerized
with phosphate ionic liquids

| Ionic liquid | | Time^{b} | Mn^{c} | Mw^{c} | PDI^{c} |
|---|---|---|---|---|---|
| [IL] | M:IL^{a} | [h] | [g/mol] | [g/mol] | Mw/Mn |
| ODTMA DMP | 50 | 1 | 45800 | 100800 | 2.2 |
| | 250 | 1 | 47900 | 115000 | 2.4 |
| | 1000 | 1 | 54500 | 120000 | 2.2 |
| Mmim DMP | 50 | 24 | 11300 | 56900 | 3.0 |
| | 250 | 24 | 32600 | 93700 | 2.9 |
| | 1000 | 24 | 55800 | 172500 | 3.1 |
| TTMAP | 50 | 3 | 4200 | 17100 | 4.0 |
| | 250 | 3 | 8100 | 43600 | 5.4 |
| | 1000 | 3 days | 53200 | 262400 | 4.2 |
| K₃PO₄ | 50 | 24 | 92800 | 681500 | 7.4 |
| | 250 | 24 | 118400 | 405000 | 3.4 |
| | 1000 | 6 days | 135600 | 364500 | 2.7 |
| a-lecithin | 50 | 24 | 33600 | 299300 | 8.9 |
| | 250 | 24 | 52900 | 348900 | 6.6 |
| | 1000 | 24 | 108000 | 341500 | 3.1 |

^{a}Monomer [bPL] to ionic liquid molar ratio in MTBE solvent [~1.6M].
^{b}Time to reach greater than 99.9% conversion of bPL.
^{c}Number average molar mass [Mn], weighted average molar mass [Mw], and polydispersity index [PDI] determine by GPC in CHCl₃ versus PMMA standards.

Ammonium phosphate salts are highly effective additives for the polymerization of beta-propiolactone. The most active phosphate salt is ODTMA DMP yield >99% conversion of bPL and producing high molar mass P3HP in less than 1h [Mw=>120000 g/mol; PDI=2.2]. Imidazolium salts, such as mmim DMP, is effective as well, yield high molar mass polymer after 24h of reaction to reach high conversion [Mw=>172500 g/mol; PDI=3.1]. Tribasic salts are also used in the polymerization of bPL [TTMAP and tribasic potassium phosphate; K₃PO₄]. The tribasic salts showed virtually no solubility in the MTBE/bPL reaction mixture, however, these salts produced very different results for P3HP synthesis; TTMAP yielded low molar mass in relatively fast reaction times [3h; Mw=17100 g/mol; PDI=4.0] whereas K₃PO₄ yielded high molar mass after overnight stirring [24h; Mw=681500 g/mol; PDI=7.4]. The low solubility of the salts might be the cause for the slow reactivity, especially considering the basicity of the tribasic phosphate salt is much higher than the monobasic counterparts. Regardless, K₃PO₄ is an effective additive to produce high molar mass P3HP in a relatively fast reacting time [24h] and without any ammonium additive.

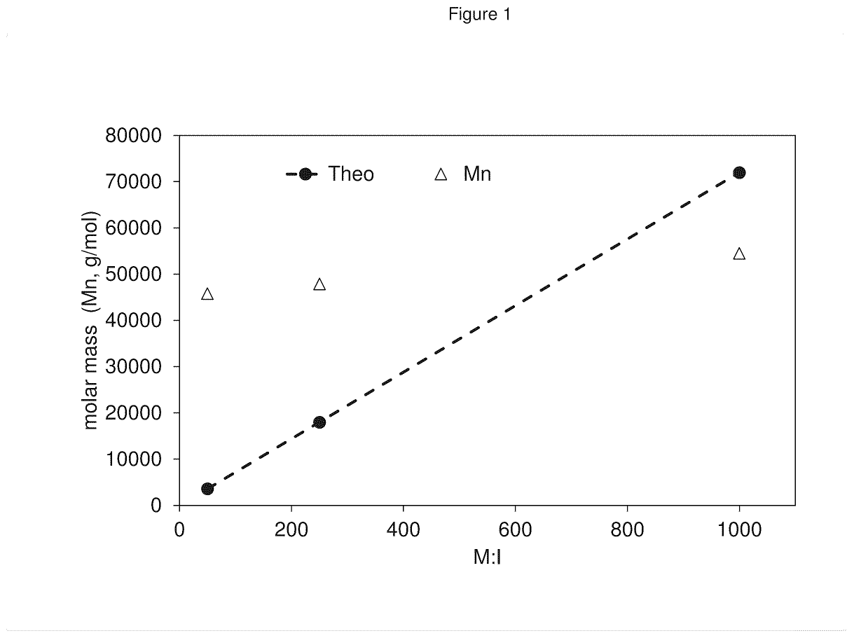

Analysis of the ratio of monomer to ionic liquid [M:IL] can provide mechanistic insights into the influence of the phosphate salt. In general, the molar mass of the resulting polymer is independent to M:IL ratio when ODTMA DMP is used in the polymerization of bPL [FIG. 1]. This suggests that the DMP anion is the not predominant initiator for the polymerization of bPL, but is reacting in a different way, such as a base or a reversible invitation event. The salt is likely not acting solely as a catalyst, as higher loadings of ODTMA DMP did not yield a faster a reaction time. On the contrary, less ODTMA DMP [M:IL ratio=1000:1] yielded complete conversion of bPL the fastest. FIG. 1 shows the molar mass [Mₙ] dependence on monobasic ionic liquid equivalence versus beta-lactone ratio. Reactions performed with ODTMA DMP ionic liquid at 40° C. in MTBE [˜1.6M]. Dashed line represents the theoretical molar mass [Theo].

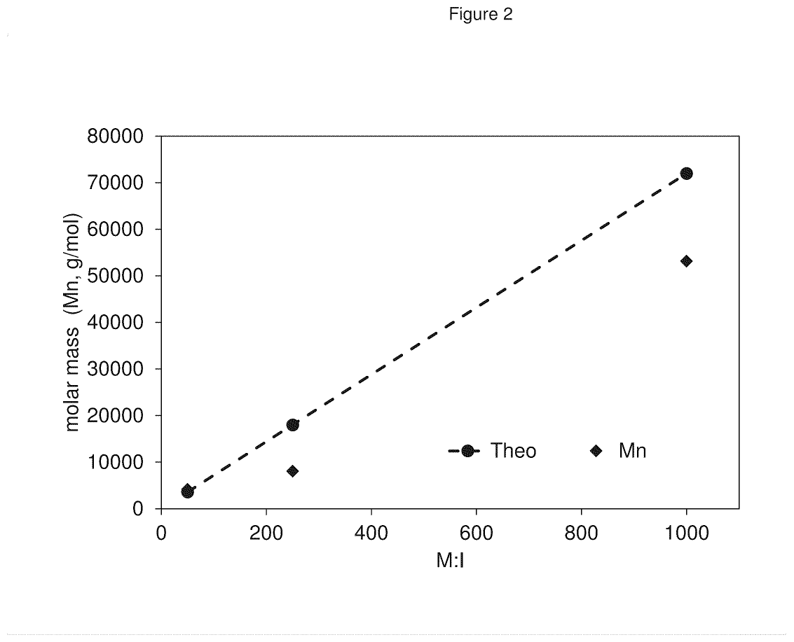

Tribasic phosphate salt, TTMAP, showed expected trends in polymerization control of bPL. That is, when more phosphate is used, the polymerization is faster and yields a lower molar mass polymer as shown in FIG. 2. This is likely due to the increased nucleophilicity of the tribasic phosphate anion and increasing the efficacy of the initiator. As a result, the theoretical molar mass based on monomer to initiator ratio is closer to the measured molar mass of the final polymer. FIG. 2 shows the molar mass [Mₙ] dependence on tribasic ionic liquid equivalence versus beta-lactone ratio. Reactions performed with TTMAP ionic liquid at 40° C. in MTBE [˜1.6M]. Dashed line represents the theoretical molar mass [Theo].

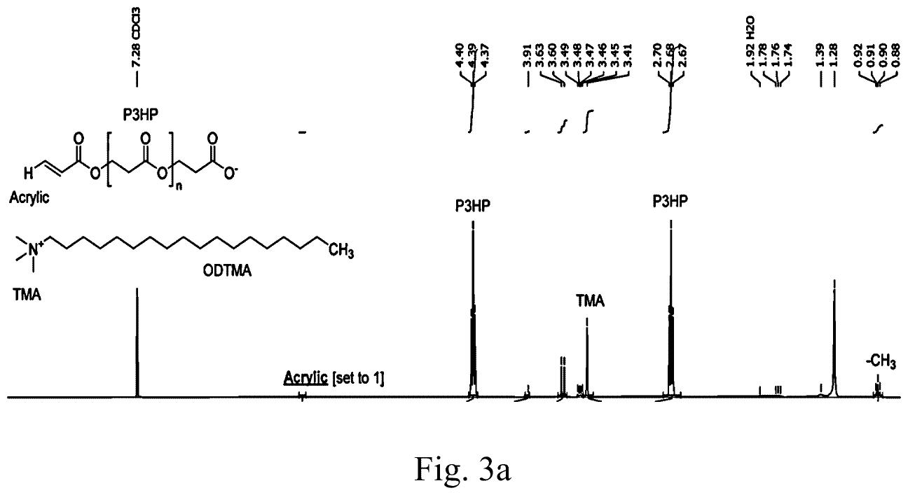

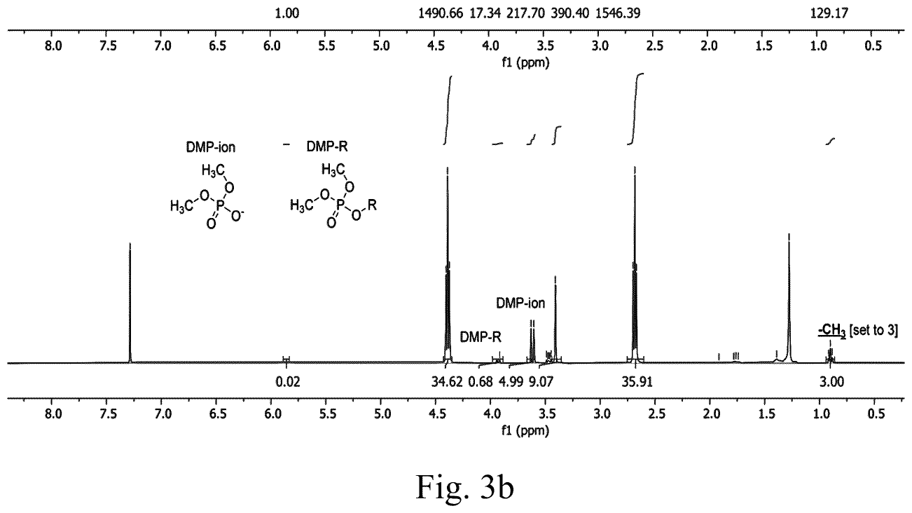

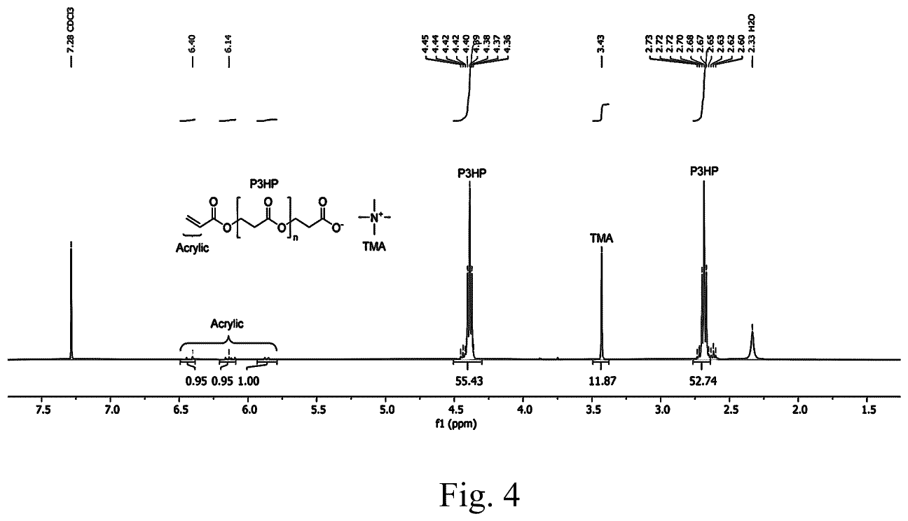

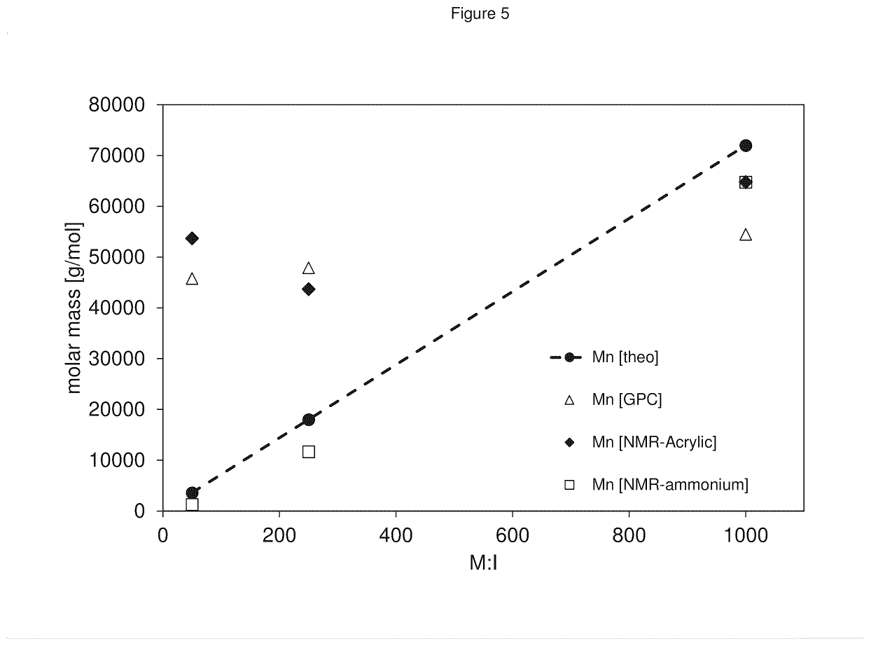

End-group analysis by 1H NMR spectroscopy reveals the major initiator group is the acrylate anion [FIGS. 3 and 4]. The molar mass using the acrylate as the end-group closely matches the measured molar mass of the polymer according to GPC analysis [Table 3 and FIG. 5]. Analysis of the dimethyl phosphate signals and the methyl groups on the ammonium group suggest that they are not covalently-linked to the polymer, but rather acrylate is the dominant end-group in these polymers.

FIG. 3 a and b show 1H NMR spectroscopy (500 MHz; CDCl₃) of P3HP prepared using octadecyl-trimethylammonium dimethyl phosphate [ODTMA DMP]. Top: integration with acylate [CHH═CH—CO-] set to 1. Bottom: integration of octadecyl-CH₃ set to 3. Reaction conditions [M:IL=50:1 in MTBE solvent (1.6M) at 40° C.]. FIG. 4 shows 1H NMR spectroscopy (500 MHz; CDCl₃) of P3HP prepared using tris(tetramethylammonium) phosphate [TTMAP]. Reaction conditions [M:IL=50:1 in MTBE solvent (1.6M) at 40° C.]

TABLE 3
End-group analysis of monobasic and tribasic phosphate
ionic liquid used in the polymerization of P3HP.

| Ionic liquid | | Mn^{b} | Mn^{c} | Mn^{d} | Mn^{e} |
|---|---|---|---|---|---|
| [IL] | M:IL^{a} | [g/mol] | [g/mol] | [g/mol] | [g/mol] |
| ODTMA DMP | 50 | 3600 | 45800 | 53700 | 1300 |
| | 250 | 18000 | 47900 | 43700 | 11700 |
| | 1000 | 72000 | 54500 | 64800 | 64800 |
| TTMAP | 50 | 3600 | 4200 | 2000 | 2000 |
| | 250 | 18000 | 8100 | 7200 | 7400 |
| | 1000 | 72000 | 53200 | 44900 | 265000^{f} |

^{a}Ratio of monomer [bPL] to ionic liquid [IL] on a molar ratio.
^{b}Theoretical molar mass based on the ratio of M:IL [ratio × 72 g/ mol]
^{c}Molar mass according to gel permeation chromatography [GPC; CHCl₃ @ 1.0 mL/min versus PMMA standards]
^{d}Molar mass according to ¹H NMR spectroscopy in CDCl₃ using the acrylic end-group; FIG. 4]
^{e}Molar mass according to ¹H NMR spectroscopy in CDCl₃ using the ammonium end-group; FIG. 3]
Reaction took >3 days to finish. Tetramethylammonium peak broadened suggesting possible side reactions.

FIG. 5. molar mass [g/mol] of P3HP using ODTMA DMP as a catalyst according to GPC and 1H NMR spectroscopy using end-group analysis.

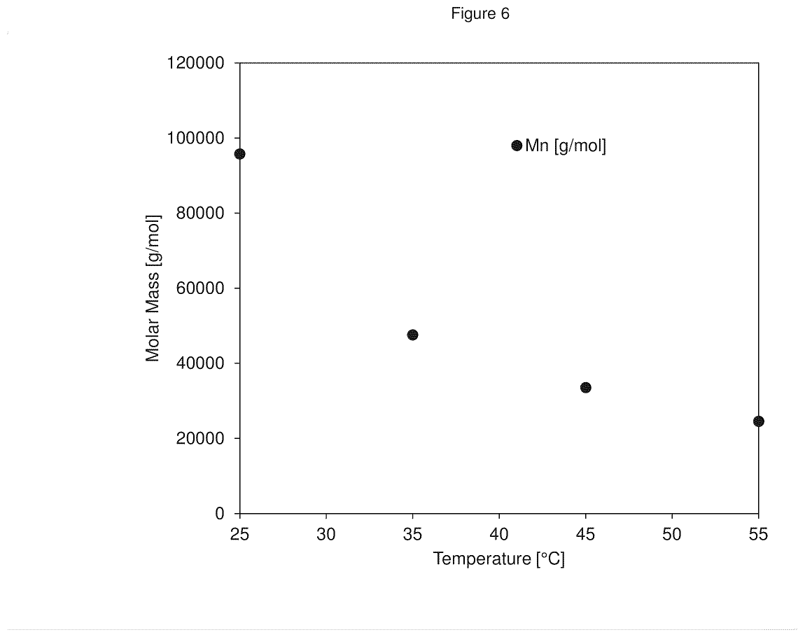

The generation of acrylate via elimination chemistry during bPL polymerization is highly dependent on the reaction temperature, that is, increased temperature yield more acrylate. That means, tailoring the reaction temperature is an effective method to change to molar mass of P3HP [Table 4 and FIG. 6].

TABLE 4
Temperature dependence on polymerization
of bPL with ODTMA DMP

| temp | | Time^{b} | Mn^{c}GPC | Mw^{c}GPC | PDI^{c} GPC | Mn NMR |
|---|---|---|---|---|---|---|
| [° C.] | M:IL^{a} | [h] | [g/mol] | [g/mol] | Mw/Mn | [g/mol] |
| 25 | 500:1 | 24 | 95800 | 287200 | 3.0 | 158400 |
| 35 | 500:1 | 24 | 47600 | 203600 | 4.3 | 52500 |
| 45 | 500:1 | 2 | 33600 | 114200 | 3.4 | 41900 |
| 55 | 500:1 | 6 | 24600 | 73200 | 3.0 | 22600 |

^{a}Monomer [bPL] to ionic liquid molar ratio.
^{b}Time to reach greater than 99.9% conversion of bPL.
^{c}Number average molar mass [Mn], weighted average molar mass [Mw], and polydispersity index [PDI] determine by GPC in CHCl₃ versus PMMA standards.

FIG. 6 shows the temperature dependence on polymer molar mass [Mₙ] using ODTMA DMP as an additive [monomer to ionic liquid ratio=500:1]. Dashed line represents the theoretical molar mass [MTheo].

The reaction solvent is another means to generate polymers of various molar masses.

TABLE 5
Solvent dependence on polymerization of bPL with ODTMA DMP

| | | Time^{b} | Mn^{c} | Mw^{c} | PDI^{c} |
|---|---|---|---|---|---|
| Solvent | M:IL^{a} | [h] | [g/mol] | [g/mol] | Mw/Mn |
| MTBE | 500:1 | 2 | 33600 | 114200 | 3.4 |
| THF | 500:1 | 24 | 15000 | 46500 | 3.1 |
| EtOAc | 500:1 | 24 | 17000 | 59500 | 3.5 |
| IPA | 500:1 | 6 days | 900 | 2100 | 2.3 |

^{a}Monomer [bPL] to ionic liquid molar ratio.
^{b}Time to reach greater than 99.9% conversion of bPL.
^{c}Number average molar mass [Mn], weighted average molar mass [Mw], and polydispersity index [PDI] determine by GPC in CHCl₃ versus PMMA standards.

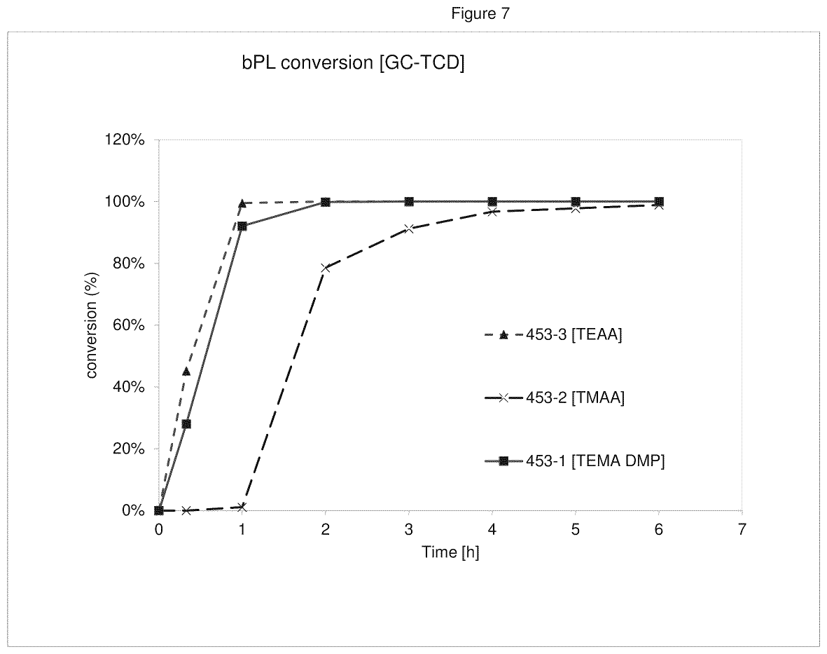

FIG. 7 shows the comparison of betalactone conversion versus time with various polymerization additives.

TABLE 6
Salt dependence on polymerization of Betalactone

| | | Time^{b} | Mn^{c} | Mw^{c} | PDI^{c} |
|---|---|---|---|---|---|
| salt | M:IL^{a} | [h] | [g/mol] | [g/mol] | Mw/Mn |
| TEMA DMP | 2000 | 2 | 95500 | 238800 | 2.5 |
| TEAA | 2000 | 2 | 56100 | 106600 | 1.9 |
| TMAA | 2000 | 24 | 46000 | 101200 | 2.2 |

^{a}Monomer [bPL] to salt molar ratio in MTBE solvent [~1.6M].
^{b}Time to reach greater than 99.9% conversion of bPL.
^{c}Number average molar mass [Mn], weighted average molar mass [Mw], and polydispersity index [PDI] determine by GPC in CHCl₃ versus PMMA standards.

The foregoing has been a description of certain non-limiting embodiments of the invention. Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A polymer comprising one or more polymer chains having ring opened betalactone units and having on one end of a portion of the polymer chains a residue of a phosphate anion covalently bonded to the one end of the polymer chains and on a second end of a portion of the polymer chains is one or more onium containing cations:
wherein the phosphate anion corresponds to formula; 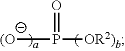
wherein R² is separately in each occurrence an optionally substituted carbon containing group;
a is separately in each occurrence 1, 2 or 3; and
b is separately in each occurrence 0, 1 or 2;
wherein sum of a and b is 3.

2. The polymer according to claim 1 wherein the one or more onium containing cations contain one or more of nitrogen, phosphorus, sulfur, antimony or arsenic.

3. The polymer according to claim 1, wherein the one or more onium containing cations comprise one or more quaternary nitrogen containing cations or quaternary phosphonium containing cations.

4-13. (canceled)

14. A The polymer according to claim 1, wherein the one or more polymer chains have the residue of an end capping agent or quenching agent on a portion of ends of chains.

15. The polymer according to claim 1, wherein the polymer contains a comonomer which polymerizes with ring opened beta propiolactone and/or substituted beta propiolactone.

16-17. (canceled)

18. The polymer according to claim 1, wherein the polymers correspond to one of formulas: 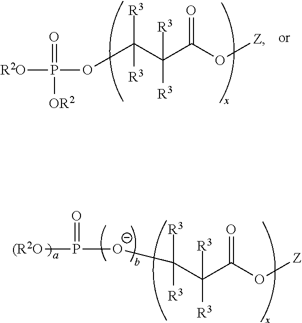
wherein R² is separately in each occurrence an optionally substituted carbon containing group
R³ is separately in each occurrence hydrogen, a carbon containing group; which may optionally contain one or more heteroatoms and/or substituents
a is separately in each occurrence 1, 2 or 3;
b is separately in each occurrence 0, 1 or 2;
x is separately in each occurrence about a real number of greater than 1; and
Z is separately in each occurrence hydrogen, the residue of an onium cation, the residue of a quenching agent, a capping agent, or hydrogen.

19. The polymer according to claim 1, wherein a portion of the polymer chains have a carboxylate group on the one end of some of the chains.

20. A The polymer according to claim 1, wherein a portion of the polymer chains may have a carboxylate group on the one end of some of the polymer chains which correspond to the formula: 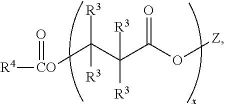
wherein R² is separately in each occurrence an optionally substituted carbon containing group
R³ is separately in each occurrence hydrogen, a carbon containing; which may optionally contain one or more heteroatoms and/or substituents
R⁴ is independently in each occurrence a carbon containing group which may contain a heteroatom or be substituted with a functional group;
a is separately in each occurrence 1, 2 or 3;
b is separately in each occurrence 0, 1 or 2;
x is separately in each occurrence a real number of greater than 1, and
Z is separately in each occurrence hydrogen, the residue of an onium cation, the residue of a quenching agent, an end capping agent or hydrogen.

21. A polymerizable composition comprising:
a. one or more of beta propiolactone and/or substituted beta propiolactones; and
b. one or more salts of one or more onium cations and one or more phosphate anions:
wherein the one or more salts of one or more onium cations and one or more phosphate anions corresponds to formula 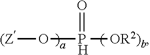
wherein R² is separately in each occurrence an optionally substituted carbon containing group;
Z′ is separately in each occurrence an onium cation;
a is separately in each occurrence 1, 2 or 3; and
b is separately in each occurrence 0, 1 or 2;
wherein sum of a and b is 3.

22. The polymerizable composition according to claim 21 wherein the one or more onium cations contain one or more of nitrogen, phosphorus, sulfur, antimony or arsenic.

23. The polymerizable composition according to claim 21, wherein the one or more onium cations comprise one or more quaternary nitrogen containing cations or quaternary phosphonium containing cations.

24. The polymerizable composition according to claim 23, wherein the one or more quaternary nitrogen containing cations or quaternary phosphonium cations are one or more tetraalkyl ammonium anions or tetraalkyl phosphonium anions.

25-35. (canceled)

36. The polymerizable composition according to claim 23, wherein the one or more salts of one or more quaternary nitrogen containing cations or quaternary phosphonium cations and one or more phosphate anions corresponds to one of formulas: 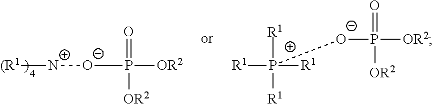
wherein R¹ is separately in each occurrence a carbon containing group wherein two or more of R¹ may form one or more aromatic or non-aromatic ring structures which may optionally contain one or more heteroatoms; and
wherein R² is separately in each occurrence a carbon containing group.

37-45. (canceled)

46. The polymerizable composition according to claim 21, comprising one or more comonomers which copolymerize with the one or more of beta-propiolactone and/or substituted beta propiolactones.

47. The polymerizable composition according to claim 21, comprising one or more of chain transfer agents, chain extenders, quenching agents and end capping agents.

48-52. (canceled)

53. A method comprising contacting the elements of the polymerizable composition of claim 21, under conditions to prepare one or more polymers comprising one or more polymer chains having ring opened beta-lactone units.

54. The method according to claim 53 wherein the elements are contacted at a temperature of from about 30° C. to about 120° C., and at a pressure of between about 1 bar (0.1 MPa) and about 20 bar (2.0 MPa).

55-57. (canceled)

58. The method according to claim 53, wherein after a specified reaction time, or when the polymer composition has reached a desired molecular weight an end capping agent is added, wherein the end capping agents comprises one or more electrophilic organic compounds.

59. (canceled)

60. The method according to claim 53, wherein the elements are contacted in a solvent which is a non-polar-solvent or a polar solvent ether, an alkanol, or an acetate.

61-63. (canceled)

64. The method according to claim 53, wherein the polymer formed is contacted with a polyepoxide or a polylactone to under conditions such that the polymer is crosslinked through terminal groups of the polymer.

65-67. (canceled)
